(19) United States
(12) Patent Application Publication
(10) Pub. No.: US 2024/0264346 A1
(43) Pub. Date: Aug. 8, 2024

(54) LIGHT ABSORBER, LIGHT-ABSORBER-ATTACHED ARTICLE, AND LIGHT-ABSORBING COMPOSITION

(71) Applicant: Nippon Sheet Glass Company, Limited, Tokyo (JP)

(72) Inventor: Yuichiro KUBO, Tokyo (JP)

(21) Appl. No.: 18/561,665

(22) PCT Filed: May 13, 2022
(86) PCT No.: PCT/JP2022/020277

§ 371 Date: Nov. 16, 2023

(30) Foreign Application Priority Data
May 17, 2021 (JP) 2021-083428

(51) Int. Cl. G02B 5/22; G02B 5/00

(52) U.S. Cl. CPC G02B 5/22; G02B 5/003

(57) ABSTRACT

A transmission spectrum measured for the light absorber 10 at an incident angle of 0° satisfies the following requirements: (I) an average transmittance in a wavelength range of 480 nm to 580 nm is 78% or more; (II) a maximum transmittance in a wavelength range of 350 nm to 380 nm is 1% or less; (III) a maximum transmittance in a wavelength range of 800 nm to 950 nm is 7% or less; and (IV) a transmittance at a wavelength of 400 nm is 10% or less.

### TECHNICAL FIELD

The present invention relates to a light absorber, an article with the light absorber, and a light-absorbing composition.

### BACKGROUND ART

In imaging apparatuses employing a solid-state image sensing device such as a charge coupled device (CCD) or a complementary metal oxide semiconductor (CMOS), any of various optical filters is disposed ahead of the solid-state image sensing device in order to obtain an image with good color reproduction. Solid-state image sensing devices generally have spectral sensitivity over a wide wavelength range extending from ultraviolet to infrared regions. On the other hand, the visual sensitivity of humans lies solely in the visible region. Thus, a technique is known in which an optical filter for blocking a portion of infrared or ultraviolet is disposed ahead of a solid-state image sensing device in an imaging apparatus in order to allow the spectral sensitivity of the solid-state image sensing device to approximate to the visual sensitivity of humans.

It has been common for such an optical filter to block infrared light or ultraviolet light by means of light reflection by a dielectric multilayer film. Recent interest has focused on optical filters including a film that includes a light absorbent. The transmittance properties of an optical filter including a film that includes a light absorbent are unlikely to be dependent on the incident angle, and this makes it possible to obtain favorable images with less color change even when light is obliquely incident on the optical filter in an imaging apparatus. Good backlit or nightscape images are easily obtainable using light-absorbing type optical filters not including a light-reflecting film because such optical filters can reduce occurrence of ghosting and flare caused by multiple reflection in a light-reflecting film. Moreover, optical filters including a light-absorber-including film are advantageous also in terms of size reduction and thickness reduction of imaging apparatuses.

Light absorbents made of a phosphonic acid and a copper ion are known for such use. For example, Patent Literature 1 describes an optical filter including a light-absorbing layer including a light absorber including a copper ion and a phosphonic acid (phenyl-based phosphonic acid) having a phenyl group or a halogenated phenyl group.

Patent Literature 2 describes an optical filter including a UV-IR absorbing layer capable of absorbing infrared light and ultraviolet light. The UV-IR absorbing layer includes a UV-IR absorbent including a phosphonic acid and a copper ion. A UV-IR absorbing composition includes, for example, a phenyl-based phosphonic acid and a phosphonic acid (alkyl-based phosphonic acid) having an alkyl group or a halogenated phenyl group so that the optical filter will satisfy predetermined optical properties.

Patent Literature 3 describes an infrared cut filter including an organic-dye-including layer and a copper-phosphonate-including layer.

Patent Literature 4 describes an optical filter including an absorbing layer, a reflective layer, and a transparent substrate. A spectral transmittance curve measured for the optical filter at an incident angle of 0° satisfies given requirements. The absorbing layer includes a near-infrared-absorbing dye such as a squarylium dye.

### CITATION LIST

### Patent Literature

Patent Literature 1: JP 6339755 B1
Patent Literature 2: JP 6232161 B1
Patent Literature 3: JP 6281023 B2
Patent Literature 4: WO 2020/004641 A1

### SUMMARY OF INVENTION

### Technical Problem

It is difficult to say that the optical filters described in Patent Literatures 1 to 4 sufficiently block light in a near-ultraviolet region, particularly a region around a wavelength of 400 nm. This cannot be an advantage in color reproducibility in images. Moreover, the optical filter described in Patent Literature 4 needs a reflective layer to supplement the insufficient light blocking performance of the absorbing layer with the reflective layer. A complicated step of forming the reflective layer is thus required for the optical filter described in Patent Literature 4.

Therefore, the present invention provides a light absorber that is capable of satisfactorily blocking light in a near-infrared region and a near-ultraviolet region.

### Solution to Problem

The present invention provides a light absorber having a transmission spectrum at an incident angle of 0°, the transmission spectrum satisfying the following requirements (I), (II), (III), and (IV):
(I) an average transmittance in a wavelength range of 480 nm to 580 nm is 78% or more;
(II) a maximum transmittance in a wavelength range of 350 nm to 380 nm is 1% or less; (III) a maximum transmittance in a wavelength range of 800 nm to 950 nm is 7% or less; and
(IV) a transmittance at a wavelength of 400 nm is 10% or less.

The present invention also provides an article with the light-absorber including:
an article; and
the light absorber provided on at least a portion of a surface of the article.

The present invention also provides a light-absorbing composition capable of being cured to form a light absorber that has a transmission spectrum of light incident on the light absorber at an incident angle of 0°, the transmission spectrum satisfying the following requirements (i), (ii), (iii), and (iv):
(i) an average transmittance in a wavelength range of 480 nm to 580 nm is 78% or more;
(ii) a maximum transmittance in a wavelength range of 350 nm to 380 nm is 1% or less;
(iii) a maximum transmittance in a wavelength range of 800 nm to 950 nm is 7% or less; and
(iv) a transmittance at a wavelength of 400 nm is 10% or less.

### Advantageous Effects of Invention

The above light absorber is capable of satisfactorily blocking light in a near-infrared region and a near-ultraviolet region.

### BRIEF DESCRIPTION OF DRAWINGS

FIG. 1A is a cross-sectional view showing an example of a light absorber according to the present invention.

FIG. 1B is a cross-sectional view showing an example of an article with a light absorber according to the present invention.

FIG. 2 shows an example of an imaging apparatus according to the present invention.

FIG. 3A shows transmission spectra of an optical filter according to Example 1.

FIG. 3B shows transmission spectra of the optical filter according to Example 1.

FIG. 3C shows transmission spectra of the optical filter according to Example 1.

FIG. 4A shows transmission spectra of an optical filter according to Example 2.

FIG. 4B shows transmission spectra of the optical filter according to Example 2.

FIG. 4C shows transmission spectra of the optical filter according to Example 2.

FIG. 5A shows transmission spectra of an optical filter according to Example 3.

FIG. 5B shows transmission spectra of the optical filter according to Example 3.

FIG. 5C shows transmission spectra of the optical filter according to Example 3.

FIG. 6A shows transmission spectra of an optical filter according to Example 4.

FIG. 6B shows transmission spectra of the optical filter according to Example 4.

FIG. 6C shows transmission spectra of the optical filter according to Example 4.

FIG. 7 shows a transmission spectrum of an optical filter according to Comparative Example 1.

FIG. 8 shows transmission spectra of an optical filter according to Comparative Example 2.

FIG. 9 shows transmission spectra of an optical filter according to Comparative Example 3.

FIG. 10 shows a transmission spectrum of an optical filter according to Comparative Example 4.

FIG. 11 shows a transmission spectrum of an optical filter according to Comparative Example 5.

FIG. 12 shows a transmission spectrum of a glass substrate.

### DESCRIPTION OF EMBODIMENTS

Embodiments of the present invention will be described hereinafter. The following description relates to examples of the present invention, and the present invention is not limited to the embodiments given below.

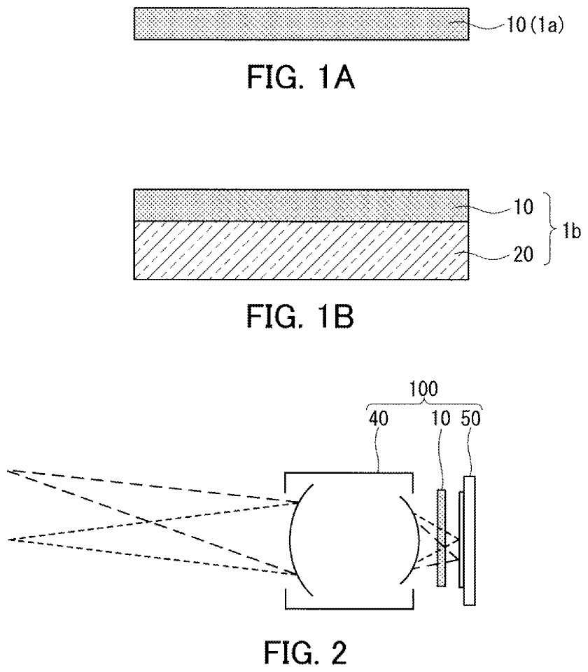

FIG. 1A is a cross-sectional view showing a light absorber 10. A transmission spectrum measured for the light absorber 10 at an incident angle of 0° satisfies the following requirements (I), (II), (III), and (IV).
(I) An average transmittance T^{A}₀₍₄₈₀₋₅₈₀₎ in an wavelength range of 480 nm to 580 nm is 78% or more.
(II) A maximum transmittance T^{M}₀₍₃₅₀₋₃₈₀₎ in a wavelength range of 350 nm to 380 nm is 1% or less.
(III) A maximum transmittance T^{M}₀₍₈₀₀₋₉₅₀₎ in a wavelength range of 800 nm to 950 nm is 7% or less.
(IV) A transmittance T₀₍₄₀₀₎ at a wavelength of 400 nm is 10% or less.

Since the requirement (I) is satisfied, the amount of light that is in a visible light range and that passes through the light absorber 10 is large. Because of this, for example, when the light absorber 10 is included in an imaging apparatus, the amount of light that is in the visible light range and that reaches an image sensing device tends to be large. The average transmittance T^{A}₀₍₄₈₀₋₅₈₀₎ is desirably 80% or more, more desirably 82% or more, and even more desirably 84% or more. The terms “visible light region” and “visible light range” can refer to, for example, the wavelength range of 380 nm to 780 nm.

Since the requirement (II) is satisfied, the light absorber 10 can satisfactorily block light in an ultraviolet region. Because of this, for example, transmission properties of the light absorber 10 can be adjusted to properties similar to those of a relative luminous efficiency curve (visibility spectrum) of humans having no sensitivity outside the visible light region. The terms “ultraviolet region” and “ultraviolet range” can refer to a range from a wavelength of 280 nm to a wavelength below the lower limit, e.g., 380 nm, of the visible light range. To block light in the ultraviolet region also includes to block light in a wavelength range belonging to a part of the ultraviolet region. The relative luminous efficiency curve of humans is a curve representing the photopic standard relative luminous efficiency defined in International Commission on Illumination (CIE).

As to the requirement (II), the transmission spectrum measured for the light absorber 10 at an incident angle of 0° desirably satisfies the following requirement (IIa), and more desirably satisfies the following requirement (IIb).

(IIa) The maximum transmittance T^{M}₀₍₃₅₀₋₃₈₅₎ in the wavelength range of 350 nm to 385 nm is 1% or less.
(IIb) The maximum transmittance T^{M}₀₍₃₅₀₋₃₉₀₎ in the wavelength range of 350 nm to 390 nm is 1% or less.

Since the requirement (III) is satisfied, the light absorber 10 can satisfactorily block light in a near-infrared region. For example, the transmission properties of the light absorber 10 are easily adjusted to properties similar to those of the relative luminous efficiency curve of humans having no sensitivity outside the visible light region. The maximum transmittance T_{M}⁰⁽⁸⁰⁰⁻⁹⁵⁰⁾ is desirably 5% or less, and more desirably 3% or less. The terms “near-infrared region” and “near-infrared light range” generally refer to the wavelength range of 780 nm to 2500 nm; herein, the near-infrared region and the near-infrared light range can be a range from a wavelength longer than the upper limit, e.g., 780 nm, of the visible light range to 1200 nm. To block light in the near-infrared region includes to block light in a wavelength range belonging to a part of the near-infrared region.

As to the requirement (III), the transmission spectrum measured for the light absorber 10 at an incident angle of 0° desirably further satisfies the following requirement (IIIa). In this case, more reliably, the transmission properties of the light absorber 10 are easily adjusted to properties similar to those of the relative luminous efficiency curve of humans having no sensitivity outside the visible light region. A maximum transmittance T^{M}₀₍₈₀₀₋₁₁₀₀₎ is, desirably 7% or less, and more desirably 5% or less.

(IIIa) The maximum transmittance T^{M}₀₍₈₀₀₋₁₁₀₀₎ in the wavelength range of 800 nm to 1100 nm is 10% or less.

According to the photopic standard relative luminous efficiency defined in International Commission on Illumination (CIE), the sensitivity at a wavelength of 400 nm is extremely low in the relative luminous efficiency curve of humans. Since the requirement (IV) is satisfied, the transmission properties of the light absorber 10 are easily adjusted to properties similar to those of the relative luminous efficiency curve of humans. Consequently, for example, when the light absorber 10 is included in an imaging apparatus, good color reproduction is likely to be achieved in images obtained by such an imaging apparatus. For example, when an imaging apparatus includes a non-RGB color filter such as a CMY (cyan, magenta, yellow) color filter or another color filter having a high sensitivity to ultraviolet, a light absorber having a high transmittance in a region around a wavelength of 400 nm can be a disadvantage in color reproducibility in images obtained by the imaging apparatus. However, the above disadvantage in color reproducibility is likely to be reduced in the case where the light absorber 10 is used. The transmittance T₀₍₄₀₀₎ is desirably 5% or less, and more desirably 3% or less.

Moreover, purple fringing can be reduced for images taken using an imaging apparatus including an optical filter satisfying the requirement (IV) or an imaging apparatus including an optical filter satisfying the requirements (II) and (IV). Purple fringing refers to a phenomenon in which a purple part appears at a boundary between a high-brightness part and a low-brightness part, on an outline of a subject, or at a vicinity thereof. One of the causes of this phenomenon is thought to be chromatic aberration of magnification of an optical system, such as a lens, included in an imaging apparatus. An optical filter included in an imaging apparatus and satisfying the requirement (IV) or the requirements (II) and (IV) can block a portion of purple light and can reduce occurrence of purple fringing or the effect of purple fringing.

The transmission spectrum measured for the light absorber 10 at an incident angle of 0° further satisfies, for example, the following requirement (V). A first wavelength λ⁵⁰_{0(UV)} defined below is close to the lower limit of a wavelength range of light that passes through the light absorber 10. When the following requirement (V) is satisfied, the light absorber 10 can block light belonging to the ultraviolet region, the light being invisible to human eyes.

(V) The first wavelength λ⁵⁰_{0(UV)} that lies in the wavelength range of 350 nm to 480 nm and at which a transmittance is 50% lies in a range of 405 nm to 480 nm.

As to the requirement (V), the first wavelength λ⁵⁰_{0(UV)} desirably lies in the range of 405 nm to 470 nm.

The transmission spectrum measured for the light absorber 10 at an incident angle of 0° further satisfies, for example, the following requirement (VI). When this requirement is satisfied, the light absorber 10 can block light invisible to human eyes and belonging to the infrared region. Additionally, when the requirement (VI) is satisfied, a second wavelength λ⁵⁰_{0(IR)} defined below is close to a wavelength at which a relative luminous efficiency value V(λ) is 0.5 in the luminous efficiency curve of humans where a relative luminous efficiency value V(555) at a wavelength of 555 nm is 1, and the transmission spectrum of the light absorber 10 are easily adjusted so as to have properties similar to those of the relative luminous efficiency curve of humans.

(VI) The second wavelength λ⁵⁰_{0(IR)} that lies in the wavelength range of 600 nm to 800 nm and at which a transmittance is 50% lies in a range of 680 nm to 760 nm.

As to the requirement (VI), the second wavelength λ⁵⁰_{0(IR)} lies desirably in the range of 690 nm to 750 nm, and more desirably in the range of 700 nm to 740 nm.

The transmission spectrum measured for the light absorber 10 at an incident angle of 0° further satisfies, for example, the following requirement (VII). In this case, light having a longer wavelength belonging to the infrared region can also be blocked satisfactorily. Satisfactorily blocking such light makes it easy to adjust the transmission properties of the light absorber 10 to properties similar to those of the relative luminous efficiency curve of humans having no sensitivity outside the visible light region.

Moreover, even when the light absorber 10 is used along with a sensor, such as an image sensing device or a photodiode, having sensitivity to light with a wavelength around 1200 nm, satisfactorily blocking light having a longer wavelength belonging to the infrared region is an advantage in that light with a wavelength around 1200 nm is appropriately blocked. A maximum transmittance T^{M}₀₍₈₀₀₋₁₂₀₀₎ is desirably 10% or less, and more desirably 3% or less.

(VII) The maximum transmittance T^{M}₀₍₈₀₀₋₁₂₀₀₎ in the wavelength range of 800 nm to 1200 nm is 15% or less.

The transmission spectrum measured for the light absorber 10 at an incident angle of 0° further satisfies, for example, the following requirements (VIII) and (IX). The relative luminous efficiency curve of humans shows the highest sensitivity V(λ) at a wavelength of 550 nm. Because of this, for the light absorber 10, a high transmittance at a wavelength of 550 nm is an advantage in that the similarity to the luminous efficiency curve of humans is high. In particular, for the light absorber 10 satisfying the following requirements (VIII) and (IX), a ratio of a transmittance at a wavelength of 550 nm to each of transmittances at 400 nm and 800 nm, which are wavelengths of light desirably blocked, is high. This makes it possible to adjust the transmission properties of the light absorber 10 to properties similar to qualitative properties of the relative luminous efficiency curve of humans.

(VIII) A ratio T₀₍₅₅₀₎/T₀₍₄₀₀₎ of a transmittance T₀₍₅₅₀₎ at a wavelength of 550 nm to the transmittance T₀₍₄₀₀₎ at a wavelength of 400 nm is 8 or more.
(IX) A ratio T₀₍₅₅₀₎/T₀₍₈₀₀₎ of the transmittance T₀₍₅₅₀₎ at a wavelength of 550 nm to a transmittance T₀₍₈₀₀₎ at a wavelength of 800 nm is 8 or more.

The ratio T₀₍₅₅₀₎/T₀₍₄₀₀₎ is desirably 12 or more, more desirably 16 or more, even more desirably 24 or more, and particularly desirably 32 or more. The ratio T₀₍₅₅₀₎/T₀₍₈₀₀₎ is desirably 12 or more, more desirably 16 or more, even more desirably 24 or more, and particularly desirably 32 or more.

The transmission spectrum measured for the light absorber 10 at an incident angle of 0° further satisfies, for example, the following requirement (X). In this case, for the light absorber 10, the transmittance of light at a wavelength around 680 nm is easily adjusted to a desired height.

(X) A ratio T₀₍₆₈₀₎/T₀₍₈₀₀₎ of a transmittance T₀₍₆₈₀₎ at a wavelength of 680 nm to the transmittance T₀₍₈₀₀₎ at a wavelength of 800 nm is 8 or more.

It is conceivable, for example, to equip a vehicle with, as part of an in-vehicle system, a camera including a CMOS sensor or the like. It is also conceivable to include such a camera in a driving apparatus, a moving apparatus, or a conveyance apparatus such as a drone, an autonomous robot, or the like. In such cases, the camera is used mainly to obtain information, such as images, of external situations, and drivers, operators, and behaviors of automatic steering control systems are supported on the basis of the obtained information. In this situation, a camera including an optical filter having a high transmittance in the visible light range, especially in a red bandwidth, has an advantage in that the external environment is recognized with higher accuracy, the optical filter being capable of satisfactorily blocking infrared. An optical filter's having a high transmittance in the red band is important to accurately recognize red lights, traffic signs, and nearby moving objects. The term “red band” herein refers to the wavelength range from 580 nm to 780 nm. Red sometimes represents danger and safety on traffic lights, road signs, and the like. Examples thereof include red lights and, in the category of traffic signs (road signs), regulatory signs indicating no vehicle entry, stop, slow, etc.

For accurate recognition of red lights, regulatory signs, etc., as described above, and nearby moving objects, it is important for a transmission spectrum of an optical filter to show a high transmittance in a wavelength range of red. Red colors on regulatory signs, etc. have a high reflectance, for example, in a wavelength range from a minimum wavelength of 580 to 620 nm to a maximum wavelength of about 780 nm, although the wavelength range depends on specifications of retro-reflective sheets. Assuming that the maximum wavelength of the visible light range is 780 nm, a transmission spectrum of an optical filter is advantageous when the transmittance in the wavelength range of, for example, 580 nm to 780 nm, particularly 620 nm to 760 nm, or especially 620 nm to 750 nm is equal to or higher than a particular level in the transmission spectrum. Furthermore, an optical filter's being capable of satisfactorily blocking infrared is important so as to ease a problem such as a camera's being affected by infrared sensing by a vehicle driving nearby, a moving apparatus, or a conveyance apparatus and thus incapable of taking good images. A system including such a camera can be a sensing system, such as a light detection and ranging (Lidar) system, using a laser. In this case, transmission of light with a wavelength of 800 nm is sometimes undesirable. The light absorber 10 satisfying the above requirement (X) has an advantage from the viewpoint of inclusion of the light absorber 10 in sensing systems using lasers. T₀₍₆₈₀₎/T₀₍₈₀₀₎ is desirably 12 or more, more desirably 16 or more, even more desirably 24 or more, and particularly desirably 32 or more.

In a reflection spectrum measured for the light absorber 10 at an incident angle of 0°, for example, a reflectance R₀₍₈₀₀₋₁₀₀₀₎ in the wavelength range of 800 nm to 1000 nm is 20% or less. The reflectance R₀₍₈₀₀₋₁₀₀₀₎ is desirably 10% or less. In the reflection spectrum measured for the light absorber 10 at an incident angle of 0°, a reflectance R₀₍₈₀₀₋₁₂₀₀₎ in the wavelength range of 800 nm to 1200 nm is desirably 20% or less. The reflectance R₀₍₈₀₀₋₁₂₀₀₎ is more desirably 10% or less.

A transmission spectrum measured for the light absorber 10 at an incident angle of 35° has, for example, a third wavelength λ⁵⁰_{35(UV)} that lies in the wavelength range of 350 nm to 480 nm and at which a transmittance is 50%. An absolute value |λ⁵⁰_{35(UV)}−λ⁵⁰_{0(UV)} of a difference between the third wavelength λ⁵⁰_{35(UV)} and the first wavelength λ⁵⁰_{0(UV)} is, for example, 5 nm or less. Additionally, the transmission spectrum measured for the light absorber 10 at an incident angle of 35° has, for example, a fourth wavelength λ⁵⁰_{35(IR)} that lies in the wavelength range of 600 nm to 800 nm and at which a transmittance is 50%. An absolute value |λ⁵⁰_{35(IR)}−λ⁵⁰_{0(IR)}| of a difference between the fourth wavelength λ⁵⁰_{35(IR)} and the second wavelength λ⁵⁰_{0(IR)} is, for example, 10 nm or less.

When the absolute value |λ⁵⁰_{35(UV)}−λ⁵⁰_{0(UV)}| is 5 nm or less and the absolute value |λ⁵⁰_{35(IR)}−λ⁵⁰_{0(IR)}| is 10 nm or less for the transmission spectrum of the light absorber 10, the transmission spectrum of the light absorber 10 is likely to have a small incident angle dependency. In the case where light belonging to a particular wavelength region is blocked by an optical filter including a light-reflecting film consisting of a dielectric multilayer film, a transmission spectrum of the optical filter has a large incident angle dependency on the incident angle of light incident on the light-reflecting film. For example, depending on the angle at which light is incident on the optical filter, the entire transmission spectrum of the optical filter shifts toward the short wavelength side. This shift of the transmission spectrum affects color shades of light passing through the optical filter. In an image obtained in this case, a central portion created by a contribution of a ray having a small incident angle and a peripheral portion created by a contribution of a ray having a large incident angle show different color shades, which may be recognized as color unevenness in the image. For example, the peripheral portion of the image is blue tinted. On the other hand, the transmission spectrum of the light absorber 10 has a small incident angle dependency. That makes it easy to reduce color unevenness appearing by visualizing a digital image obtained using an image sensing device or the like.

The absolute value |λ⁵⁰_{35(UV)}−λ⁵⁰_{0(UV)}| is desirably 4 nm or less, and more desirably 3 nm or less. The absolute value |λ⁵⁰_{35(IR)}−λ⁵⁰_{0(IR)}| is desirably 8 nm or less, and more desirably 6 nm or less.

A transmission spectrum measured for the light absorber 10 at an incident angle of 45° has, for example, a wavelength λ⁵⁰_{45(UV)} that lies in the wavelength range of 350 nm to 480 nm and at which a transmittance is 50%. An absolute value |λ⁵⁰_{45(UV)}−λ⁵⁰_{0(UV)}| of a difference between the wavelength λ⁵⁰_{45(UV)} and the first wavelength λ⁵⁰_{0(UV)} is, for example, 10 nm or less, desirably 8 nm or less, and more desirably 6 nm or less. The transmission spectrum measured for the light absorber 10 at an incident angle of 45° has, for example, a wavelength λ⁵⁰_{45(IR)} that lies in the wavelength range of 600 nm to 800 nm and at which a transmittance is 50%. An absolute value |λ⁵⁰_{45(IR)}−λ⁵⁰_{0(IR)}| of a difference between the wavelength λ⁵⁰_{45(IR)} and the second wavelength λ⁵⁰_{0(IR)} is, for example, 15 nm or less, desirably 13 nm or less, and more desirably 11 nm or less.

A transmission spectrum measured for the light absorber 10 at an incident angle of 55° has, for example, a wavelength λ⁵⁰_{55(UV)} that lies in the wavelength range of 350 nm to 480 nm and at which a transmittance is 50%. An absolute value |λ⁵⁰_{5(UV)}−λ⁵⁰_{0(UV)}| of a difference between the wavelength λ⁵⁰_{55(UV)} and the first wavelength λ⁵⁰_{0(UV)} is, for example, 15 nm or less, desirably 12 nm or less, and more desirably 9 nm or less. The transmission spectrum measured for the light absorber 10 at an incident angle of 55° has, for example, a wavelength λ⁵⁰_{55(IR)} that lies in the wavelength range of 600 nm to 800 nm and at which a transmittance is 50%. An absolute value |λ⁵⁰_{55(IR)}−λ⁵⁰_{0(IR)}| of a difference between the wavelength λ⁵⁰_{55(IR)} and the second wavelength λ⁵⁰_{0(IR)} is, for example, 20 nm or less, desirably 18 nm or less, and more desirably 16 nm or less.

Components included in the light absorber 10 are not limited to particular ones as long as the above requirements (I), (II), (III), and (IV) are satisfied. The light absorber 10 includes, for example, a copper component, at least one metal component other than copper, and phosphorus.

The light absorber 10 can be obtained, for example, by curing a given light-absorbing composition. Components included in the light-absorbing composition are not limited to particular ones as long as the light absorber 10 satisfies the above requirements (I), (II), (III), and (IV). The light-absorbing composition includes, for example, a light-absorbing compound, an ultraviolet absorbent, and at least one selected from the group consisting of an alkoxide including a metal component other than copper and a hydrolysate of an alkoxide including a metal component other than copper. The light-absorbing compound includes a phosphonic acid and a copper component. The ultraviolet absorbent is capable of absorbing at least a portion of ultraviolet.

The phosphonic acid in the light-absorbing compound is not limited to a particular phosphonic acid as long as the transmission spectrum measured for the light absorber 10 at an incident angle of 0° satisfies the requirements (I), (II), (III), and (IV). The phosphonic acid is, for example, represented by the following formula (a). In the formula (a), R₁ is an alkyl group or a halogenated alkyl group in which at least one hydrogen atom in an alkyl group is substituted by a halogen atom. In this case, a transmission band of the light absorber 10 is likely to extend to a wavelength around 700 nm, and the light absorber 10 is likely to have desired transmittance properties.

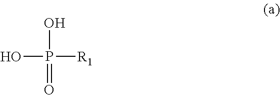

The phosphonic acid is, for example, methylphosphonic acid, ethylphosphonic acid, normal(n-)propylphosphonic acid, isopropylphosphonic acid, normal(n-)butylphosphonic acid, isobutylphosphonic acid, sec-butylphosphonic acid, tert-butylphosphonic acid, or bromomethylphosphonic acid.

In preparation of the light-absorbing composition, a source of the copper component in the light-absorbing compound is not limited to a particular substance. The source of the copper component is, for example, a copper salt. The copper salt may be an anhydride or a hydrate of copper chloride, copper formate, copper stearate, copper benzoate, copper pyrophosphate, copper naphthenate, or copper citrate. For example, copper acetate monohydrate is represented by Cu(CH₃COO)₂·H₂O, and 1 mol of copper acetate monohydrate provides 1 mol of copper ion.

The ultraviolet absorbent is not limited to a particular compound as long as the transmission spectrum measured for the light absorber 10 at an incident angle of 0° satisfies the requirements (I), (II), (III), and (IV). The ultraviolet absorbent is, for example, a compound having a hydroxy group and a carbonyl group in a molecule.

Examples of requirements for advantageous ultraviolet absorbents include: having an appropriate light absorption range and an appropriate light transmission range; having photochemical stability; having a weak photosensitization effect as far as the photosensitization effect exerts no influence on use of an ultraviolet absorbent; and having thermochemical stability. From the above viewpoints, using a photoexcitation-induced transfer reaction (a hydrogen abstraction reaction in a molecule) of a hydrogen atom in the hydroxy group in a molecule is conceivable as a mechanism of light absorption by the ultraviolet absorbent. Examples of an ultraviolet absorbent that exhibits such a mechanism include compounds such as hydroxybenzophenone, salicylic acid, hydroxyphenyl benzotriazole, hydroxyphenyl triazine, and a substituted acrylonitrile. In hydroxybenzophenone and salicylic acid, a reaction involving transfer of a hydrogen atom between a hydroxy group and a carbonyl group in a molecule relates to absorption of light such as ultraviolet light. On the other hand, in hydroxyphenyl benzotriazole, hydroxyphenyl triazine, and a substituted acrylonitrile, a reaction involving transfer of a hydrogen atom between a hydroxy group and a nitrogen atom in a molecule relates to absorption of light such as ultraviolet light. It is inferred that since these ultraviolet absorbents have a hydroxy group having an unshared electron pair in a molecule, these ultraviolet absorbents undergo an interaction, such as partial complexation, with a coexistent metal component or a coexistent hydrogen donor. In a system including a light-absorbing composition that contains an ultraviolet absorbent, a cured product thereof, or the like, a case where an ultraviolet absorbent having a hydroxy group is present independently and a case where an ultraviolet absorbent having a hydroxy group is coexistent with a metal component or a hydrogen donor are compared. According to the comparison, optical properties such as light absorption spectra and light transmission spectra of the light-absorbing compositions and the cured products are different, which supports the above inference. According to the comparison, a phenomenon in which a light absorption band in the wavelength range of 300 to 500 nm shifts toward the long wavelength side occurs, in particular, in a light absorber obtained by curing a light-absorbing composition including a metal component other than copper and an ultraviolet absorbent having a hydroxy group and a carbonyl group in a molecule. Such a light absorber has an advantage in effectively and appropriately absorbing light with a wavelength around 400 nm. It should be noted that the shifting of the light absorption band toward the long wavelength side can bring to the surface, for example, a phenomenon in which the maximum absorption wavelength in the wavelength range of 300 nm to 500 nm in a transmission spectrum shifts toward the long wavelength side or in which the wavelength (UV cut-off wavelength) at which the transmittance is 50% shifts toward the long wavelength side. As can be understood from the above, according to the light absorber being a cured product of the above light-absorbing composition, the inherent absorption properties of the ultraviolet absorbent can be adjusted so that light in a short wavelength region can be effectively absorbed. Thus, the light absorber 10 is likely to have desired transmittance properties.

Disposition of the hydroxy group and the carbonyl group in the ultraviolet absorbent is not limited to particular disposition. In the ultraviolet absorbent, the hydroxy group and the carbonyl group are desirably disposed with one to three atoms interposed between the hydroxy group and the carbonyl group. In this case, in the ultraviolet absorbent, a hydrogen atom is thought to be likely to transfer between the hydroxy group and the carbonyl group. This is likely to effectively cause the phenomenon in which the light absorption band in the wavelength range of 300 to 500 nm shifts toward the long wavelength side. Consequently, effective and appropriate absorption of light with a wavelength around 400 nm is likely to be more reliably achieved by the light absorber 10.

The ultraviolet absorbent is desirably a compound unlikely to form an aggregate when mixed with the metal component. The ultraviolet absorbent desirably includes a benzophenone-based compound represented by the following formula (A1). In this case, the transmittance T₀₍₄₀₀₎ of the light absorber 10 at a wavelength of 400 nm is likely to be effectively decreased.

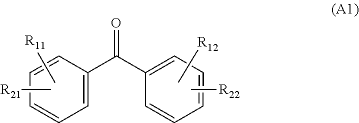

In the formula (A1), at least one of R₁₁, R₁₂, R₂₁, and R₂₂ is a hydroxy group. In the formula (A1), in the case where R₁₁, R₁₂, R₂₁, or R₂₂ is a functional group other than a hydroxy group, a plurality of R₁₁s, a plurality of R₁₂s, a plurality of R₂₁s, or a plurality of R₂₂s may be present and at least one of R₁₁, R₁₂, R₂₁, and R₂₂ may be absent.

In the case where R₁₁, R₁₂, R₂₁, or R₂₂ is a functional group other than a hydroxy group, the functional group is, for example, a carboxyl group, an aldehyde group, a halogen atom, an alkyl group having 1 to 12 carbon atoms, an alkyl group that has 1 to 12 carbon atoms and in which one or more hydrogen atoms are substituted by a halogen atom, an alkoxy group having 1 to 12 carbon atoms, or an alkoxy group that has 1 to 12 carbon atoms and in which one or more hydrogen atoms are substituted by a halogen atom.

The ultraviolet absorbent more desirably includes a benzophenone-based compound represented by the following formula (A2). In this case, effective and appropriate absorption of light in a short wavelength region around 400 nm is likely to be more reliably achieved by the light absorber 10.

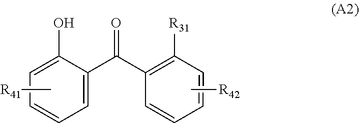

In the formula (A2), R₃₁ is a hydrogen atom, a hydroxy group, a carboxyl group, an aldehyde group, a halogen atom, a halogen-containing group, an alkyl group having 1 to 12 carbon atoms, or an alkoxy group having 1 to 12 carbon atoms. In the formula (A2), R₄₁ and R₄₂ may each be a hydroxy group, a carboxyl group, an aldehyde group, a halogen-containing group, an alkyl group having 1 to 12 carbon atoms, an aryl group having 6 to 12 carbon atoms, or an alkoxy group having 1 to 12 carbon atoms, or R₄₁ and R₄₂ may be absent. In the formula (A2), a plurality of R₄₁s may be present, and a plurality of R₄₂s may be present. The halogen-containing group may be a halogenated alkyl group in which at least one hydrogen atom in an alkyl group is substituted by a halogen atom. The halogen-containing group may be a halogenated aryl group in which at least one hydrogen atom in an aryl group is substituted by a halogen atom. The halogen-containing group may be a halogenated alkoxy group in which at least one hydrogen atom in an alkoxy group is substituted by a halogen atom.

The benzophenone-based compound represented by the formula (A1) or (A2) is not limited to a particular compound. The benzophenone-based compound is, for example, at least one selected from the group consisting of 2,2′-dihydroxy-4,4′-dimethoxybenzophenone, 2,2′,4,4′-tetrahydroxybenzophenone, 2-hydroxy-4-methoxybenzophenone, 2-hydroxy-4-methoxy-4′-chlorobenzophenone, 2-hydroxy-4-n-octoxybenzophenone, 2-hydroxy-4-dodecyloxybenzophenone, 2,4-dihydroxybenzophenone, 2-hydroxy-4-methoxy-2′-carboxybenzophenone, 2,2′-dihydroxy-4-methoxybenzophenone, 2,2′-dihydroxy-4-n-octoxybenzophenone, 2-hydroxy-5-chlorobenzophenone, and 2,4-dibenzoylresorcin.

The ultraviolet absorbent may include a salicylic-acid-based compound represented by the following formula (B). In this case, effective and appropriate absorption of light in a short wavelength region around 400 nm is likely to be more reliably achieved by the light absorber 10.

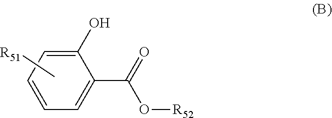

In the formula (B), R₅₁ may be a hydroxy group, a carboxy group, a halogen-containing group, an alkyl group having 1 to 12 carbon atoms, an aryl group having 6 to 12 carbon atoms, or an alkoxy group having 1 to 12 carbon atoms. In the formula (B), a plurality of R₅₁s may be present or R₅₁ may be absent. In the formula (B), R₅₂ is a hydrogen atom, an aryl group, or a halogenated aryl group in which one or more hydrogen atoms are substituted by a halogen atom. The halogen-containing group may be a halogenated alkyl group in which at least one hydrogen atom in an alkyl group is substituted by a halogen atom. The halogen-containing group may be a halogenated aryl group in which at least one hydrogen atom in an aryl group is substituted by a halogen atom. The halogen-containing group may be a halogenated alkoxy group in which at least one hydrogen atom in an alkoxy group is substituted by a halogen atom.

The salicylic-acid-based compound represented by the formula (B) is not limited to a particular compound. The salicylic-acid-based compound represented by the formula (B) includes, for example, at least one selected from the group consisting of phenyl salicylate, 4-butylphenyl salicylate, and octylphenyl salicylate.

As described above, the light-absorbing composition includes, for example, an alkoxide compound being at least one selected from the group consisting of an alkoxide including a metal component other than copper and a hydrolysate of an alkoxide including a metal component other than copper. The metal component other than copper of the alkoxide compound is not limited to a particular metal component. The metal component is typically a thermally and chemically stable component not forming an aggregate in the light-absorbing composition and the light absorber 10. Moreover, the metal component is typically a component capable of interacting with the above-described ultraviolet absorbent. The metal component includes, for example, at least one selected from the group consisting of Li, Na, Mg, Ca, Sr, Ba, Ge, Sn, Pb, Al, Ga, In, TI, Zn, Cd, Cu, Ag, Au, Ni, Pd, Pt, Co, Rh, Ir, Fe, Mn, Cr, Mo, W, V, Nb, Ta, Ti, and Zr. In this case, the metal component is likely to interact with the above-described ultraviolet absorbent. The metal component includes, desirably, at least one selected from the group consisting of Al, Ti, Zr, Zn, Sn, and Fe.

When the light-absorbing composition includes the light-absorbing compound, the ultraviolet absorbent, and the alkoxide compound, it is desirable that, for the light absorber 10, the first wavelength λ⁵⁰_{0(UV)} be longer than a fifth wavelength λ⁵⁰_{0(UV)R} and an absolute value |λ⁵⁰_{0(UV)R}−λ⁵⁰_{0(UV)}| of a difference between the fifth wavelength λ⁵⁰_{0(UV)R} and the first wavelength λ⁵⁰_{0(UV)} be 20 nm or more. The fifth wavelength λ⁵⁰_{0(UV)R} is a wavelength that is in a transmission spectrum measured for a reference light absorber at an incident angle of 0°, that lies in the wavelength range of 350 nm to 480 nm, and at which a transmittance is 50%. The reference light absorber is obtained by curing a composition including the ultraviolet absorbent included in the light-absorbing composition, the composition being free of the above alkoxide compound.

The light absorber 10 and the light-absorbing composition further include, for example, a phosphoric acid ester. The phosphoric acid ester facilitates dispersion of the light-absorbing compound in the light absorber 10. The phosphoric acid ester may function as a dispersant for the light-absorbing compound. A portion of the phosphoric acid ester may react with the metal component to form a compound. For example, the phosphoric acid ester may coordinate to the light-absorbing compound or may react with the compound.

The phosphoric acid ester is not limited to a particular phosphoric acid ester. The phosphoric acid ester has, for example, a polyoxyalkyl group. Examples of the phosphoric acid ester include PLYSURF A208N (polyoxyethylene alkyl (C12, C13) ether phosphoric acid ester), PLYSURF A208F (polyoxyethylene alkyl (C8) ether phosphoric acid ester), PLYSURF A208B (polyoxyethylene lauryl ether phosphoric acid ester), PLYSURF A219B (polyoxyethylene lauryl ether phosphoric acid ester), PLYSURF AL (polyoxyethylene styrenated phenylether phosphoric acid ester), PLYSURF A212C (polyoxyethylene tridecyl ether phosphoric acid ester), and PLYSURF A215C (polyoxyethylene tridecyl ether phosphoric acid ester). All of these are products manufactured by DKS Co., Ltd. Examples of the phosphoric acid ester include NIKKOL DDP-2 (polyoxyethylene alkyl ether phosphoric acid ester), NIKKOL DDP-4 (polyoxyethylene alkyl ether phosphoric acid ester), and NIKKOL DDP-6 (polyoxyethylene alkyl ether phosphoric acid ester). All of these are products manufactured by Nikko Chemicals Co., Ltd.

The light absorber 10 and the light-absorbing composition further include, for example, a resin. The resin is not limited to a particular resin as long as the transmission spectrum measured for the light absorber 10 at an incident angle of 0° satisfies the requirements (I), (II), (III), and (IV). Examples of the resin include a cyclic polyolefin resin, an epoxy-based resin, a polyimide-based resin, a modified acrylic resin, a silicone resin, and a polyvinyl-based resin such as PVB. The resin can be a cured product of a curable resin that can be cured by irradiation of energy such as heat or light.

The amounts of the components in the light absorber 10 and the light-absorbing composition are not limited to particular values as long as the transmission spectrum measured for the light absorber 10 at an incident angle of 0° satisfies the requirements (I), (II), (III), and (IV). In the light absorber 10 and the light-absorbing composition, a ratio of the amount of the ultraviolet absorbent to the amount of the copper component is, for example, 0.01 to 1, desirably 0.01 to 0.5, and more desirably 0.01 to 0.1 on a mass basis.

In the light absorber 10 and the light-absorbing composition, a ratio of the amount of the ultraviolet absorbent to the amount of a phosphorus component is, for example, 0.02 to 2, desirably 0.02 to 1, and more desirably 0.02 to 0.2 on a mass basis.

In the light absorber 10 and the light-absorbing composition, a ratio of the amount of the copper component to the amount of the phosphorus component is, for example, 1 to 3, and desirably 1.5 to 2 on a mass basis.

In the light absorber 10 and the light-absorbing composition, a ratio of the amount of the copper component to the amount of the metal component other than the copper component is, for example, 1×10² to 8×10², and desirably 2×10² to 6×10² on a mass basis.

In the light absorber 10 and the light-absorbing composition, a ratio of the amount of the phosphorus component to the amount of the metal component other than the copper component is, for example, 1×10² to 4×10², and desirably 1.5×10² to 3×10² on a mass basis.

In the light absorber 10 and the light-absorbing composition, a ratio of the amount of the phosphonic acid to the amount of the phosphoric acid ester compound is, for example, 0.5 to 2, and desirably 0.8 to 1.3 on a mass basis.

In the light absorber 10 and the light-absorbing composition, a ratio of the amount of the phosphonic acid to the amount of the phosphoric acid ester compound is, for example, 1 to 10, and desirably 3 to 6 on an amount of substance basis.

In the light absorber 10 and the light-absorbing composition, a ratio of the amount of the phosphonic acid to the amount of the copper component is, for example, 0.2 to 3, and desirably 0.5 to 1.5 on an amount of substance basis.

In the light absorber 10 and the light-absorbing composition, a ratio of the amount of the phosphonic acid to the amount of the ultraviolet absorbent is, for example, 1 to 300, desirably 10 to 100, and more desirably 20 to 70 on a mass basis.

As shown in FIG. 1A and FIG. 1B, the light absorber 10 is in the form of, for example, a film. The term “film” as used herein means a coating or a layer. The form of the light absorber 10 is not limited to a film form.

The light absorber 10 can function, for example, as an optical filter 1a. The optical filter 1a consists of, for example, the light absorber 10 alone. The method for producing the light absorber 10 is not limited to a particular method. The light absorber 10 can be produced, for example, by applying the light-absorbing composition on a given substrate and curing the resulting coating film. The light absorber 10 thus produced is peeled off the substrate. The material of the substrate may be a glass, a resin, or a metal. A surface of the substrate may have been subjected to a surface treatment such as coating with a fluorine-containing compound. The light absorber 10 may be produced by a method such as casting, compression molding, vacuum molding, press molding, injection molding, blow molding, or extrusion molding.

An article with a light absorber can also be provided using the light absorber 10. The article with the light absorber includes an article and the light absorber 10, and the light absorber 10 is provided on at least a portion of a surface of the article. One example of the article with the light absorber is an optical filter 1b as shown in FIG. 1B. The optical filter 1b includes the light absorber 10 and a transparent substrate 20. The light absorber 10 is provided on the transparent substrate 20, and is provided on at least a portion of a surface of the transparent substrate 20. The optical filter 1b can be produced, for example, by applying the light-absorbing composition on the transparent substrate 20 and curing the resulting coating film.

The transparent substrate 20 is not limited to a particular substrate. The transparent substrate 20 may include a glass, a resin, or a plastic. The glass may be a light-absorbing glass such as a copper-containing glass. The transparent substrate 20 may be a light-absorbing film or sheet including the light-absorbing compound. The transparent substrate 20 may be a plate-shaped substrate whose principal surfaces are planes parallel to each other, may be a substrate, such as a lens, having a curved surface, or may be a substrate having a fine non-flat structure at a surface of the substrate or in the substrate. Such a substrate is, for example, a diffraction grating.

The type of the transparent substrate 20 is not limited to a particular type. The transparent dielectric substrate 20 may have the absorption ability in the infrared region. The transparent dielectric substrate 20 may have an average spectral transmittance of 90% or more, for example, in the wavelength range of 350 nm to 900 nm. When the material of the transparent substrate 20 is a glass, the transparent substrate 20 can be, for example, a transparent glass substrate made of a silicate glass such as soda-lime glass or borosilicate glass or a substrate made of a phosphate or fluorophosphate glass containing a coloring component such as Cu or Co. The phosphate or fluorophosphate glass containing the coloring component is, for example, an infrared-absorbing glass, and has light-absorption properties in itself. In the case where the light absorber 10 is used along with the transparent substrate 20 made of an infrared-absorbing glass, the flexibility in designing optical filters is so high that an optical filter having desired optical properties can be produced by adjusting the light-absorption properties and transmission spectra of the light absorber 10 and the transparent substrate 20.

When the material of the transparent substrate 20 is a resin, the resin is, for example, a cycloolefin resin such as a norbornene resin, a polyarylate resin, an acrylic resin, a modified acrylic resin, a polyimide resin, a polyetherimide resin, a polysulfone resin, a polyethersulfone resin, a polycarbonate resin, or a silicone resin.

The thickness of the light absorber 10 is not limited to a particular value. A small thickness of the light absorber 10 is advantageous to meet a demand for low-profile light-absorber-including apparatuses such as imaging apparatuses. Thus, the thickness of the light absorber 10 is, for example, 200 μm or less, desirably 180 μm or less, and more desirably 150 μm or less. For example, it is conceivable that the light-absorbing compound concentration and the ultraviolet absorbent concentration in the light-absorbing composition are increased to achieve desired light-absorption properties of the light absorber and reduce the thickness of the light absorber. In this case, it may be impossible to maintain a desired dispersibility of each compound. Thus, the thickness of the light absorber 10 is, for example, 50 μm or more, desirably 60 μm or more, and more desirably 70 μm or more.

In the case where the transparent substrate 20 has a minimum transmittance of less than 80% in the wavelength range of 450 nm to 700 nm, the transparent substrate 20 is considered to have a light-blocking function and contribute to blocking of light in conjunction with the light absorber 10. In this case, the thickness of the light absorber 10 is, for example, 200 μm or less, desirably 180 μm or less, and more desirably 150 μm or less. Moreover, the thickness of the light absorber 10 is, for example, 50 μm or more, desirably 60 μm or more, and more desirably 70 μm or more. The transparent substrate 20 having a minimum transmittance of less than 80% in the wavelength range of 450 nm to 700 nm is, for example, a substrate including an infrared-absorbing glass.

The light absorber 10 may be formed in contact with an image sensing device or an optical component. Alternatively, the light absorber 10 may be formed by applying the above light-absorbing composition to an image sensing device or an optical component and curing the light-absorbing composition. An image sensing device with a light absorber or an optical component with a light absorber can be produced in this manner. Examples of the optical components include lenses and cover glasses. For example, an imaging apparatus including an image sensing device with a light absorber or an optical component with a light absorber can be provided.

The optical filters 1a and 1b each may be modified to further include another functional film such as an infrared-reflecting film or an antireflection film. Such a functional film can be provided on the light absorber 10 or the transparent substrate 20. For example, in the case where the optical filter includes an antireflection film, the transmittance in a given wavelength range (e.g., the visible light range) can be increased. The antireflection film may be configured as a layer of a low-refractive-index material such as MgF₂ or SiO₂, may be configured as a laminate composed of a layer of such a low-refractive-index material and a layer of a high-refractive-index material such as TiO₂, or may be configured as a dielectric multilayer film. The antireflection film can be formed by a method including a physical reaction such as vacuum deposition or sputtering or a method including a chemical reaction such as CVD or a sol-gel process.

The optical filter may be configured, for example, in such a manner that the light absorber 10 is disposed between two glass plates. This improves the stiffness and the mechanical strength of the optical filter. This also makes a principal surface of the optical filter hard, which is advantageous, for example, in preventing scratches. This advantage is important, in particular, in the case where a relatively flexible resin is included as a binder or a matrix in the light absorber 10.

An apparatus including the light absorber 10 can be provided. Applications of the apparatus are not limited to particular applications. Examples of the apparatus include in-vehicle cameras and in-vehicle sensors. In these apparatuses, an image sensing device or a sensor device can be protected from ultraviolet owing to the light absorber 10 having the given ultraviolet-absorbing properties. In some cases, the light absorber 10 has a high transmittance at a wavelength around 680 nm. Such a light absorber 10 can be included in sensing systems, such as Lidar systems, using an infrared or red laser. In some cases, the light absorber 10 has a high transmittance, particularly, of red light. Apparatuses including such a light absorber 10 tend to have a high ability to recognize objects such as red lights and road signs. Moreover, since the light absorber 10 can block light in a particular wavelength region by absorption, an apparatus including the light absorber 10 can reduce ghost and flare.

As shown in FIG. 2, for example, an imaging apparatus 100 including the light absorber 10 can be provided. The imaging apparatus 100 further includes, for example, a lens system 40 and an image sensing device 50. The light absorber 10 is disposed, for example, between the lens system 40 and the image sensing device 50. The imaging apparatus 100 is not limited to a particular product. The imaging apparatus 100 can be, for example, a camera module to be installed in personal digital assistants such as smartphones, an apparatus to be mounted in in-vehicle sensing modules, or an apparatus to be mounted in sensing modules in unmanned aerial vehicles such as drones and unmanned surface vehicles (USVs). The light absorber 10 may be included in an ambient light sensor.

### EXAMPLES

The present invention will be described in more detail by examples. The present invention is not limited to the examples given below. First, methods for evaluating optical filters according to Examples and Comparative Examples will be described.

### (Transmission Spectrum Measurement)

Transmission spectra were measured for the optical filters according to Examples and Comparative Examples 2 and 3 at incident angles of 0°, 35°, 45°, and 55° using an ultraviolet-visible-near-infrared spectrophotometer V-670 manufactured by JASCO

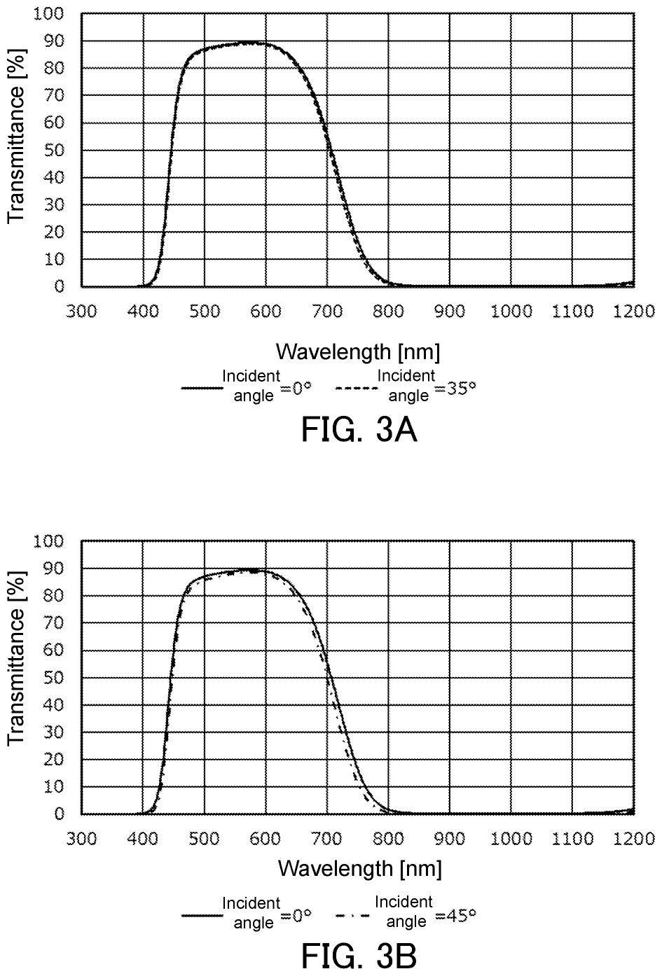

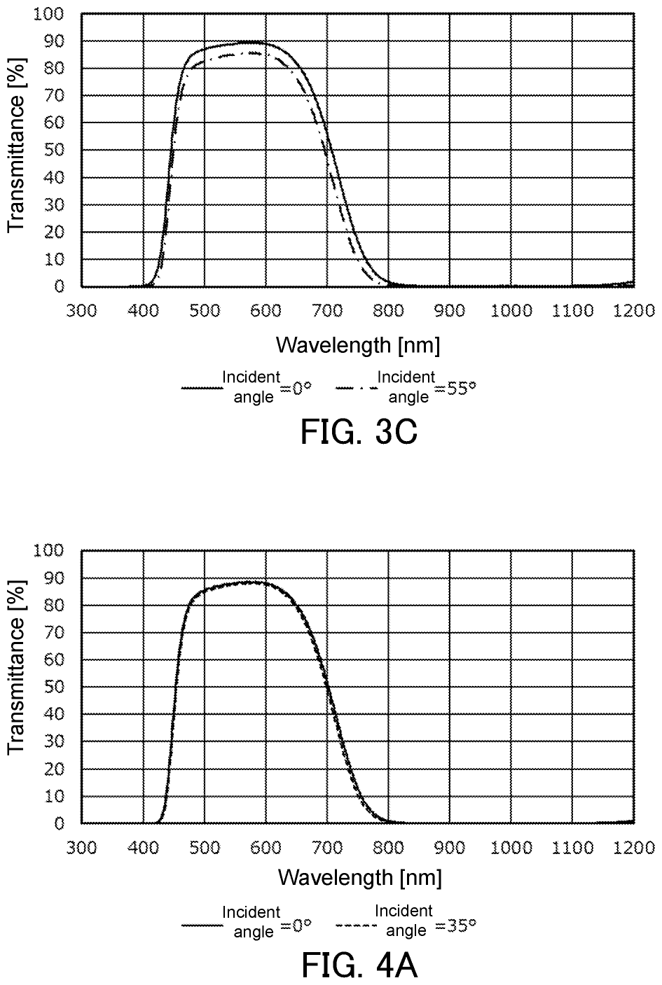

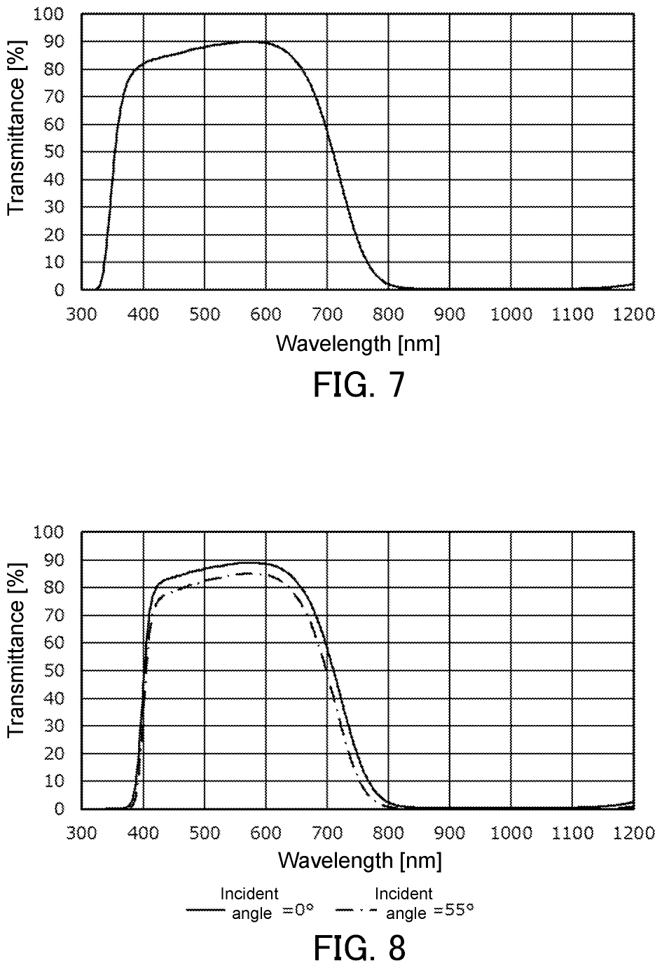

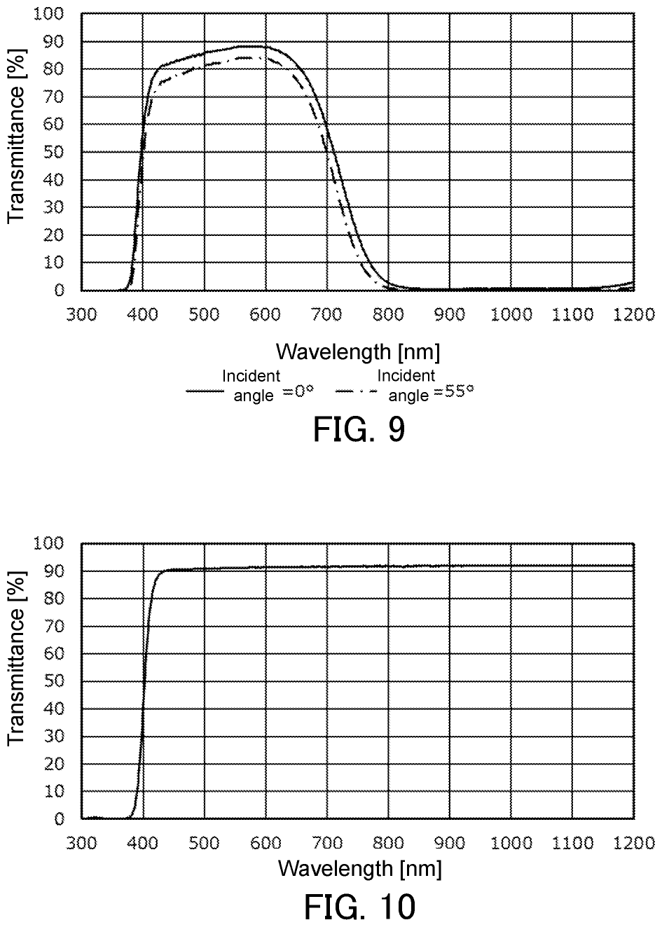

Corporation. FIGS. 3A to 6C show the results for Examples, and FIGS. 8 and 9 respectively show part of the results for Comparative Examples 2 and 3. In the same manner, transmission spectra were measured for the optical filters according to Comparative Examples 1, 4, and 5 at an incident angle of 0°. FIGS. 7, 10, and 11 show the results. Tables 3 to 6 show property values of the optical filters, the property values being obtained from these transmittance spectra. As to the items in these tables, “T_{i(λ)}” represents the transmittance at a wavelength λ nm at an incident angle i°, “T^{M}_{i(λ1-λ2)}” represents the maximum spectral transmittance in the wavelength range from A1 nm to A2 nm at an incident angle i°, and “T^{A}_{(λ1-λ12)}” represents the average spectral transmittance in the wavelength range from λ1 nm to λ2 nm at an incident angle i°. Additionally, in a transmission spectrum measured at the incident angle i°, “λ⁵⁰_{i(UV)}” represents the wavelength that lies in the wavelength range of 350 nm to 480 nm and at which the transmittance is 50%, and “λ⁵⁰_{i(IR)}” represents the wavelength that lies in the wavelength range of 600 nm to 800 nm and at which the transmittance is 50%.

### (Thickness Measurement)

The optical filters according to Examples and Comparative Examples 1 to 3 were measured for their thicknesses using a laser displacement meter LK-H008 manufactured by Keyence Corporation. Tables 3 and 4 show the results. The thickness of a light-absorbing film of each of the optical filters according to Comparative Examples 4 and 5 was measured by measuring a distance to a surface of the optical filter using a laser displacement meter LK-H008 manufactured by Keyence Corporation and then subtracting the thickness of a transparent glass substrate of the optical filter. Table 4 shows the results.

### Example 1

An amount of 4.500 g of copper acetate monohydrate and 240 g of tetrahydrofuran (THF) were mixed and then stirred for 3 hours to obtain a copper acetate solution. Next, 2.572 g of PLYSURF A208N, which is a phosphoric acid ester compound manufactured by DKS Co., Ltd., was added to the obtained copper acetate solution, and the mixture was stirred for 30 minutes to obtain a solution A1. Besides, 2.886 g of n-butylphosphonic acid and 40 g of THF were mixed and then stirred for 30 minutes to obtain a solution B1. The solution B1 was added to the solution A1 while the solution A1 was stirred, and the mixture was stirred at room temperature for 1 minute. To the resulting solution was then added 100 g of toluene, and the mixture was stirred at room temperature for 1 minute to obtain a solution C1. This solution C1 was put in a flask and subjected to solvent removal using a rotary evaporator (manufactured by Tokyo Rikakikai Co., Ltd.; product code: N-1110SF) under heating by means of an oil bath (manufactured by Tokyo Rikakikai Co., Ltd.; product code: OSB-2100). The temperature of the oil bath was controlled to 105° C. A solution which had been subjected to the solvent removal was taken out of the flask. A liquid composition D1 containing a copper component, a phosphonic acid, and a phosphoric acid ester compound was obtained in this manner. Fine particles of a light-absorbing compound including the copper component and the phosphonic acid were dispersed in the liquid composition D1 without aggregation.

An amount of 2 g of an ultraviolet absorbent Uvinul 3049 manufactured by BASF was mixed with 98 g of toluene, and the mixture was stirred for 30 minutes to obtain a liquid composition E49 including an ultraviolet absorbent. Uvinul 3049 includes 2,2′-dihydroxy-4,4′-dimethoxybenzophenone represented by the following formula (b-1).

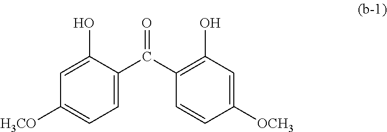 [SMILES: COc1ccc(C(=O)c2ccc(OC)cc2O)c(O)c1]

The liquid composition D1, 3 g of the liquid composition E49, 8.8 g of a silicone resin KR-300 manufactured by Shin-Etsu Chemical Co., Ltd., and 0.09 g of an aluminum alkoxide compound CAT-AC manufactured by Shin-Etsu Chemical Co., Ltd. were mixed and stirred for 30 minutes to prepare a light-absorbing composition F1 according to Example 1. The light-absorbing composition F1 includes 0.06 g of an ultraviolet absorbent. Tables 1 and 2 show the components in the light-absorbing composition F1, the amounts of the components, the mass ratios between the components, and the amount-of-substance ratio between the components. It should be noted that the average molecular weight of PLYSURF A208N used as a phosphoric acid ester was defined as 632 g/mol.

An amount of 0.1 g of an anti-smudge surface coating agent OPTOOL DSX (active ingredient concentration: 20 mass %) manufactured by DAIKIN INDUSTRIES, LTD. and 19.9 g of a hydrofluoroether-containing solution Novec 7100 manufactured by 3M Company were mixed and stirred for 5 minutes to prepare a fluorine treatment agent (active ingredient concentration: 0.1 mass %). This fluorine treatment agent was applied to a borosilicate glass (manufactured by SCHOTT AG; product name: D263 T eco) having dimensions of 130 mm×100 mm×0.70 mm by pouring. The glass substrate was left at room temperature for 24 hours to dry the coating film made of the fluorine treatment agent, and the glass surface was then wiped lightly with a dust-free cloth impregnated with Novec 7100 to remove an excess of the fluorine treatment agent. A fluorine-treated substrate was thus produced.

The light-absorbing composition F1 according to Example 1 was applied with a dispenser to a 80 mm×80 mm region at a central portion of one principal surface of the fluorine-treated substrate to form a coating film. After sufficiently dried at room temperature, the coating film was put in an oven. The temperature was gradually increased in the range of room temperature to 45° C. to evaporate the solvent for further drying. Then, a heating treatment at 85° C. for 6 minutes was performed to fully evaporate the solvent and cure the coating film. After that, the coating film was peeled off the fluorine-treated substrate to obtain an optical filter according to Example 1 consisting of a light-absorbing film. FIG. 3A, FIG. 3B, and FIG. 3C show transmission spectra measured for the optical filter according to Example 1 at incident angles of 0° and 35°, incident angles of 0° and 45°, and incident angles of 0° and 55°, respectively. As to the components included in the light-absorbing composition F1 and remaining in the light-absorbing film, the components in the light-absorbing film, the amounts of the components, the mass ratios between the components, and the amount-of-substance ratio between the components are in proportion to those shown in Tables 1 and 2.

### Example 2

A liquid composition D2 including a copper component, a phosphonic acid, and a phosphoric acid ester compound was obtained in the same manner as in the preparation of the liquid composition D1 in Example 1, except that the amount of n-butylphosphonic acid added and that of PLYSURF A208N being a phosphoric acid ester compound were adjusted as shown in Table 1. Fine particles of a light-absorbing compound including the copper component and the phosphonic acid were dispersed in the liquid composition D2 without aggregation.

The liquid composition D2, 6 g of the liquid composition E49, 8.8 g of the silicone resin KR-300 manufactured by Shin-Etsu Chemical Co., Ltd., and 0.09 g of the aluminum alkoxide compound CAT-AC manufactured by Shin-Etsu Chemical Co., Ltd. were mixed and stirred for 30 minutes to prepare a light-absorbing composition F2 according to Example 2. The light-absorbing composition F2 includes 0.12 g of an ultraviolet absorbent. Tables 1 and 2 show the components in the light-absorbing composition F2, the amounts of the components, the mass ratios between the components, and the amount-of-substance ratio between the components.

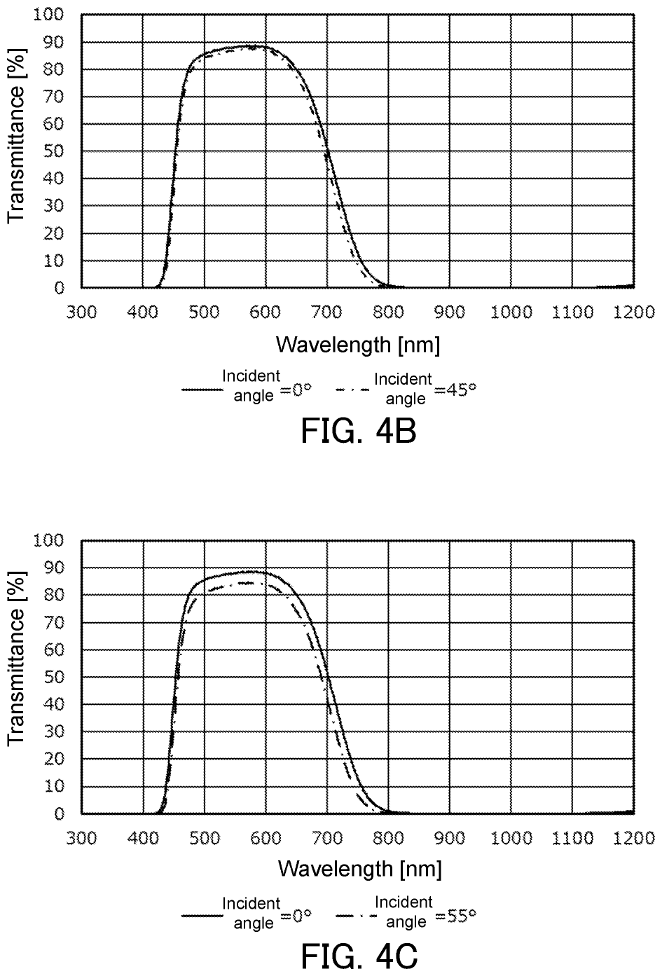

An optical filter according to Example 2 consisting of a light-absorbing film was produced in the same manner as in Example 1, except that the light-absorbing composition F2 was used instead of the light-absorbing composition F1. FIG. 4A, FIG. 4B, and FIG. 4C show transmission spectra measured for the optical filter according to Example 2 at incident angles of 0° and 35°, incident angles of 0° and 45°, and incident angles of 0° and 55°, respectively. As to the components included in the light-absorbing composition F2 and remaining in the light-absorbing film, the components in the light-absorbing film, the amounts of the components, the mass ratios between the components, and the amount-of-substance ratio between the components are in proportion to those shown in Tables 1 and 2.

### Example 3

A liquid composition D3 including a copper component, a phosphonic acid, and a phosphoric acid ester compound was obtained in the same manner as in the preparation of the liquid composition D1 in Example 1, except that the amount of n-butylphosphonic acid added and that of PLYSURF A208N being a phosphoric acid ester compound were adjusted as shown in Table 1. Fine particles of a light-absorbing compound including the copper component and the phosphonic acid were dispersed in the liquid composition D3 without aggregation.

An amount of 5 g of an ultraviolet absorbent Uvinul 3050 manufactured by BASF was mixed with 95 g of ethanol, and the mixture was stirred for 30 minutes to obtain a liquid composition E50 including an ultraviolet absorbent. Uvinul 3050 includes 2,2′,4,4′-tetrahydroxybenzophenone represented by the following formula (b-2).

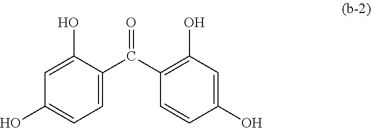 [SMILES: O=C(c1ccc(O)cc1O)c1ccc(O)cc1O]

The liquid composition D3, 0.9 g of the liquid composition E50, 8.8 g of the silicone resin KR-300 manufactured by Shin-Etsu Chemical Co., Ltd., and 0.09 g of the aluminum alkoxide compound CAT-AC manufactured by Shin-Etsu Chemical Co., Ltd. were mixed and stirred for 30 minutes to prepare a light-absorbing composition F3 according to Example 3. The light-absorbing composition F3 includes 0.045 g of an ultraviolet absorbent. Tables 1 and 2 show the components in the light-absorbing composition F3, the amounts of the components, the mass ratios between the components, and the amount-of-substance ratio between the components.

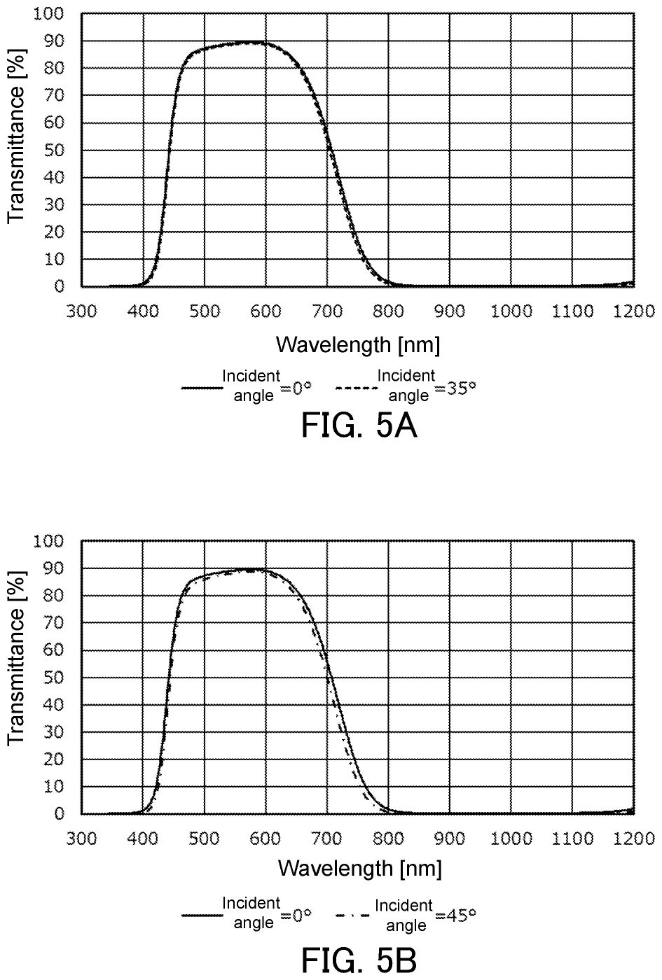

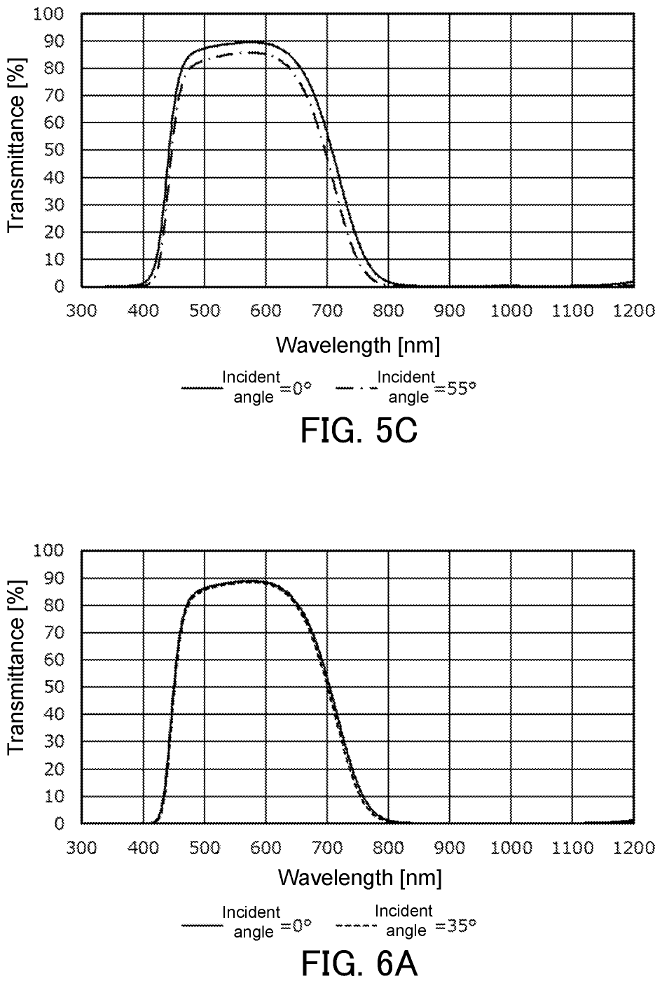

An optical filter according to Example 3 consisting of a light-absorbing film was produced in the same manner as in Example 1, except that the light-absorbing composition F3 was used instead of the light-absorbing composition F1. FIG. 5A, FIG. 5B, and FIG. 5C show transmission spectra measured for the optical filter according to Example 3 at incident angles of 0° and 35°, incident angles of 0° and 45°, and incident angles of 0° and 55°, respectively. As to the components included in the light-absorbing composition F3 and remaining in the light-absorbing film, the components in the light-absorbing film, the amounts of the components, the mass ratios between the components, and the amount-of-substance ratio between the components are in proportion to those shown in Tables 1 and 2.

### Example 4

A liquid composition D4 including a copper component, a phosphonic acid, and a phosphoric acid ester compound was obtained in the same manner as in the preparation of the liquid composition D1 in Example 1, except that the amount of n-butylphosphonic acid added and that of PLYSURF A208N being a phosphoric acid ester compound were adjusted as shown in Table 1. Fine particles of a light-absorbing compound including the copper component and the phosphonic acid were dispersed in the liquid composition D4 without aggregation.

The liquid composition D4, 1.8 g of the liquid composition E50, 8.8 g of the silicone resin KR-300 manufactured by Shin-Etsu Chemical Co., Ltd., and 0.09 g of the aluminum alkoxide compound CAT-AC manufactured by Shin-Etsu Chemical Co., Ltd. were mixed and stirred for 30 minutes to prepare a light-absorbing composition F4 according to Example 4. The light-absorbing composition F4 includes 0.09 g of an ultraviolet absorbent. Tables 1 and 2 show the components in the light-absorbing composition F4, the amounts of the components, the mass ratios between the components, and the amount-of-substance ratio between the components.

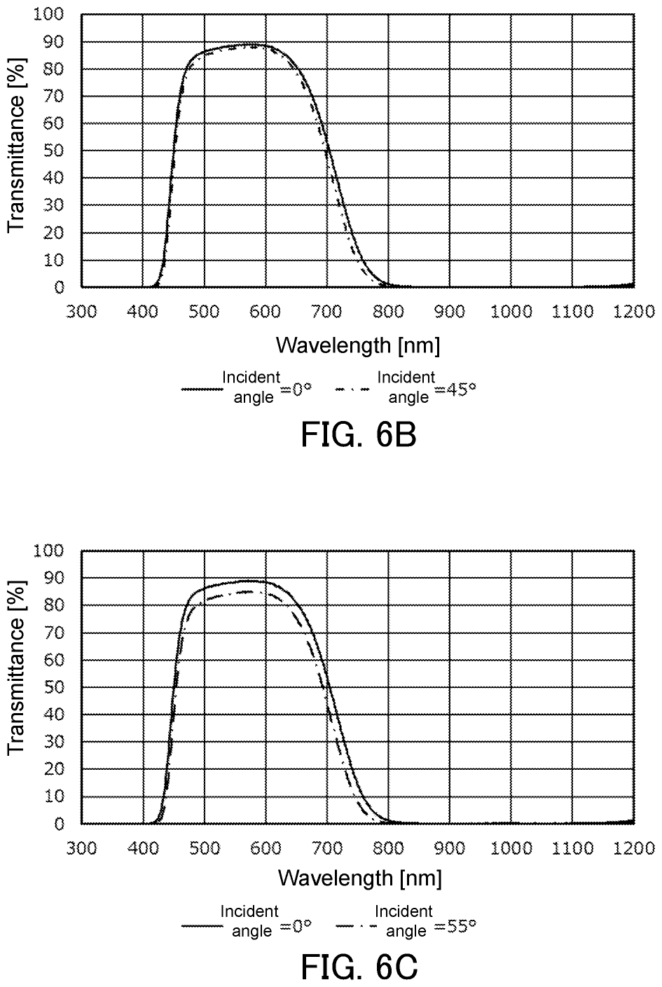

An optical filter according to Example 4 consisting of a light-absorbing film was produced in the same manner as in Example 1, except that the light-absorbing composition F4 was used instead of the light-absorbing composition F1. FIG. 6A, FIG. 6B, and FIG. 6C show transmission spectra measured for the optical filter according to Example 4 at incident angles of 0° and 35°, incident angles of 0° and 45°, and incident angles of 0° and 55°, respectively. As to the components included in the light-absorbing composition F4 and remaining in the light-absorbing film, the components in the light-absorbing film, the amounts of the components, the mass ratios between the components, and the amount-of-substance ratio between the components are in proportion to those shown in Tables 1 and 2.

### Comparative Example 1

A light-absorbing composition F5 according to Comparative Example 1 was prepared in the same manner as in Example 1, except that the liquid composition E49 was not used. Tables 1 and 2 show the components in the light-absorbing composition F5, the amounts of the components, the mass ratios between the components, and the amount-of-substance ratio between the components.

An optical filter according to Comparative Example 1 consisting of a light-absorbing film was produced in the same manner as in Example 1, except that the light-absorbing composition F5 was used instead of the light-absorbing composition F1. FIG. 7 shows a transmission spectrum measured for the optical filter according to Comparative Example 1 at an incident angle of 0°. As to the components included in the light-absorbing composition F5 and remaining in the light-absorbing film, the components in the light-absorbing film, the amounts of the components, the mass ratios between the components, and the amount-of-substance ratio between the components are in proportion to those shown in Tables 1 and 2.

### Comparative Example 2

An amount of 5 g of an ultraviolet absorbent Tinuvin 326 manufactured by BASF was mixed with 95 g of toluene, and the mixture was stirred for 30 minutes to obtain a liquid composition E326 including an ultraviolet absorbent. Tinuvin 326 includes 2-[5-chloro-(2H)-benzotriazol-2-yl]-4-methyl-6-(tert-butyl)phenol represented by the following formula (b-3).

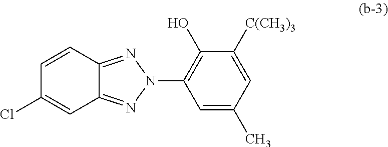 [SMILES: Cc1cc(-n2nc3ccc(Cl)cc3n2)c(O)c(C(C)(C)C)c1]

The liquid composition D1, 2.0 g of the liquid composition E326, 8.8 g of the silicone resin KR-300 manufactured by Shin-Etsu Chemical Co., Ltd., and 0.09 g of the aluminum alkoxide compound CAT-AC manufactured by Shin-Etsu Chemical Co., Ltd. were mixed and stirred for 30 minutes to prepare a light-absorbing composition F6 according to Comparative Example 2. The light-absorbing composition F6 includes 0.1 g of an ultraviolet absorbent. Tables 1 and 2 show the components in the light-absorbing composition F6, the amounts of the components, the mass ratios between the components, and the amount-of-substance ratio between the components.

An optical filter according to Comparative Example 2 consisting of a light-absorbing film was produced in the same manner as in Example 1, except that the light-absorbing composition F6 was used instead of the light-absorbing composition F1. FIG. 8 shows transmission spectra measured for the optical filter according to Comparative Example 2 at incident angles of 0° and 55°. As to the components included in the light-absorbing composition F6 and remaining in the light-absorbing film, the components in the light-absorbing film, the amounts of the components, the mass ratios between the components, and the amount-of-substance ratio between the components are in proportion to those shown in Tables 1 and 2.

### Comparative Example 3

An amount of 5 g of an ultraviolet absorbent Tinuvin 234 manufactured by BASF was mixed with 95 g of toluene, and the mixture was stirred for 30 minutes to obtain a liquid composition E234 including an ultraviolet absorbent. Tinuvin 234 includes 2-(2H-benzotriazol-2-yl)-4,6-bis(1-methyl-1-phenylethyl)phenol represented by the following formula (b-4).

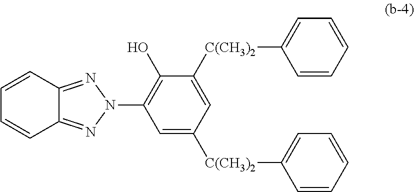

The liquid composition D1, 3.6 g of the liquid composition E234, 8.8 g of the silicone resin KR-300 manufactured by Shin-Etsu Chemical Co., Ltd., and 0.09 g of the aluminum alkoxide compound CAT-AC manufactured by Shin-Etsu Chemical Co., Ltd. were mixed and stirred for 30 minutes to prepare a light-absorbing composition F7 according to Comparative Example 3. The light-absorbing composition F7 includes 0.18 g of an ultraviolet absorbent. Tables 1 and 2 show the components in the light-absorbing composition F7, the amounts of the components, the mass ratios between the components, and the amount-of-substance ratio between the components.

An optical filter according to Comparative Example 3 consisting of a light-absorbing film was produced in the same manner as in Example 1, except that the light-absorbing composition F7 was used instead of the light-absorbing composition F1. FIG. 9 shows transmission spectra measured for the optical filter according to Comparative Example 3 at incident angles of 0° and 55°. As to the components included in the light-absorbing composition F7 and remaining in the light-absorbing film, the components in the light-absorbing film, the amounts of the components, the mass ratios between the components, and the amount-of-substance ratio between the components are in proportion to those shown in Tables 1 and 2.

### Comparative Example 4

An amount of 0.25 g of the ultraviolet absorbent Uvinul 3049 manufactured by BASF was mixed with 12.25 g of toluene, and the mixture was stirred for 30 minutes. An amount of 25 g of the silicone resin KR-300 manufactured by Shin-Etsu Chemical Co., Ltd. was added to the mixture, which was further stirred for 30 minutes. A liquid composition F8 including an ultraviolet absorbent was obtained in this manner. Tables 1 and 2 show the components in the light-absorbing composition F8, the amounts of the components, the mass ratios between the components, and the amount-of-substance ratio between the components.

The liquid composition F8 including the ultraviolet absorbent was applied with a dispenser to a 40 mm×40 mm region at a central portion of one principal surface of a transparent glass substrate (manufactured by SCHOTT AG; product name: D263 T eco) made of borosilicate glass and having dimensions of 76 mm×76 mm×0.21 mm to form a coating film. After sufficiently dried at room temperature, the coating film was put in an oven (heating furnace). The temperature was gradually increased in the range of room temperature to 45° C. to evaporate the solvent for drying. Then, the coating film was heated at 85° C. for 1 hour to fully evaporate the solvent therein and cure the coating film. A light-absorbing film including an ultraviolet absorbent was formed in this manner on the transparent glass substrate to obtain an optical filter according to Comparative Example 4. This optical filter is a filter in which a transparent glass substrate and a light-absorbing film are integrated. FIG. 10 shows an transmission spectrum measured for the optical filter according to Comparative Example 4 at an incident angle of 0°.

### Comparative Example 5

An amount of 0.25 g of the ultraviolet absorbent Uvinul 3050 manufactured by BASF was mixed with 4.75 g of ethanol, and the mixture was stirred for 30 minutes. An amount of 25 g of the silicone resin KR-300 manufactured by Shin-Etsu Chemical Co., Ltd. was added to the mixture, which was further stirred for 30 minutes. A liquid composition F9 including an ultraviolet absorbent was obtained in this manner. Tables 1 and 2 show the components in the light-absorbing composition F9, the amounts of the components, the mass ratios between the components, and the amount-of-substance ratio between the components.

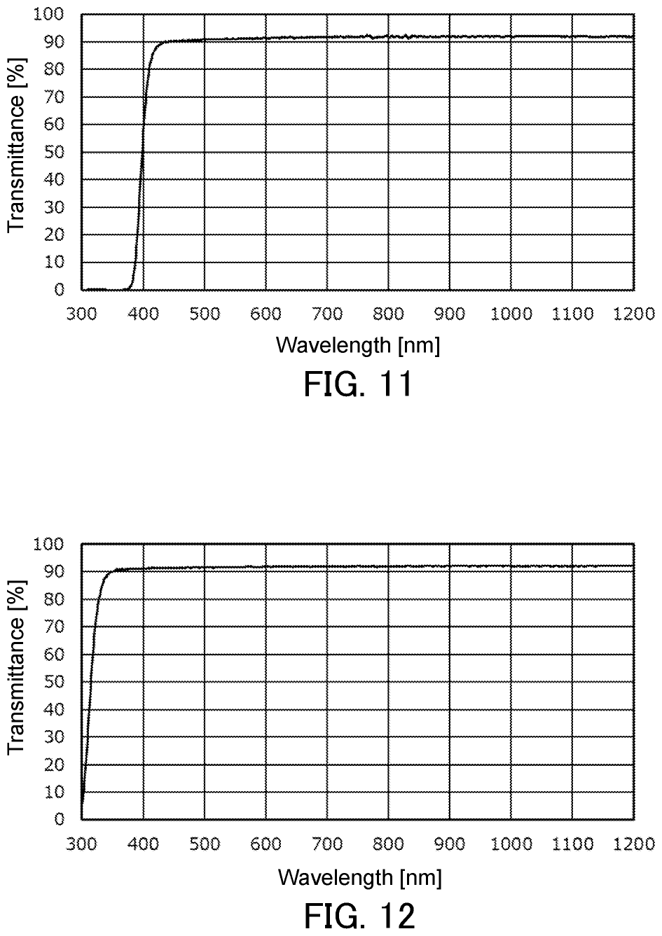

A light-absorbing film including an ultraviolet absorbent was formed on a transparent glass substrate in the same manner as in Comparative Example 4, except that the liquid composition F9 was used instead of the liquid composition F8. An optical filter according to Comparative Example 5 was obtained in this manner. This optical filter is a filter in which a transparent glass substrate and a light-absorbing film are integrated. FIG. 11 shows a transmission spectrum measured for the optical filter according to Comparative Example 5 at an incident angle of 0°.

As shown in Tables 3 and 5, the optical filters according to Examples have desired transmittance properties. On the other hand, as shown in Tables 4 and 5, the optical filters according to Comparative Examples 1 to 3 do not satisfy the above requirements (II), (IV), etc., and do not satisfy desired transmittance properties by any means.

FIG. 12 shows a transmission spectrum measured at an incident angle of 0° for a transparent glass substrate as used to produce the optical filter according to Comparative Example 4. In the transmission spectrum shown in FIG. 12, the transmittance is as high as 90% or more in the wavelength range from 350 nm, and the loss, i.e., a decrease from 100%, is attributed to Fresnel reflection at a surface of the transparent glass substrate. These indicate that the transparent glass substrate substantially hardly absorbs light in this wavelength range. Therefore, light absorption by the transparent glass substrate can be ignored in discussion about the transmission spectrum shown in FIG. 10.

For the optical filter according to Comparative Example 4, the transmittance T₀₍₄₀₀₎ at a wavelength of 400 nm is 40.78%. This probably reflects intrinsic absorption properties of Uvinul 3049 used as an ultraviolet absorbent in the light-absorbing film. Unlike the light-absorbing films according to Examples, the light-absorbing film of the optical filter according to Comparative Example 4 does not include a compound including a metal component other than copper component. Because of this, particularly a transition region located between a blocking region being a wavelength region where the transmittance is almost 0% and a transmitting region being a wavelength region where the transmittance is 70% or more does not shift toward the long wavelength side in the transmission spectrum, and neither does λ^{500(UV)}. This is thought to be the reason why the transmittance at a wavelength of 400 nm is relatively high in the transmission spectrum of the light-absorbing film according to Comparative Example 4.

For the optical filter according to Comparative Example 5, the transmittance T₀₍₄₀₀₎ at a wavelength of 400 nm is 57.15%. This probably reflects intrinsic absorption properties of Uvinul 3050 used as an ultraviolet absorbent in the light-absorbing film. Unlike the light-absorbing films according to Examples, the light-absorbing film of the optical filter according to Comparative Example 5 does not include a compound including a metal component other than copper component. Because of this, particularly a transition region located between a blocking region being a wavelength region where the transmittance is almost 0% and a transmitting region being a wavelength region where the transmittance is 70% or more does not shift toward the long wavelength side in the transmission spectrum, and neither does λ⁵⁰_{0 (UV)}. This is thought to be the reason why the transmittance at a wavelength of 400 nm is relatively high in the transmission spectrum of the light-absorbing film according to Comparative Example 5.

TABLE 1

| | Phosphonic | Phosphoric | | | | | | |
|---|---|---|---|---|---|---|---|---|
| | acid | acid ester | | | | | | |
| | n- | compound | Copper | Ultraviolet absorbent | | Curable | Aluminum alkoxide | |
| | Butyl- | [g] | acetate | | Amount | resin | | Al |
| | phosphonic | PLYSURF | monohydrate | | added | KR-300 | CAT-AC | component |
| | acid [g] | A208N [g] | [g] | Type | [g] | [g] | [g] | [g] |
| Ex. 1 | 2.886 | 2.572 | 4.500 | Uvinul | 0.060 | 8.800 | 0.090 | 0.0036 |
| | | | | 3049 | | | | |
| Ex. 2 | 2.812 | 2.939 | 4.500 | Uvinul | 0.120 | 8.800 | 0.090 | 0.0036 |
| | | | | 3049 | | | | |
| Ex. 3 | 2.757 | 3.206 | 4.500 | Uvinul | 0.045 | 8.800 | 0.090 | 0.0036 |
| | | | | 3050 | | | | |
| Ex. 4 | 2.924 | 2.405 | 4.500 | Uvinul | 0.090 | 8.800 | 0.090 | 0.0036 |
| | | | | 3050 | | | | |
| Comp. | 2.886 | 2.572 | 4.500 | — | 0.000 | 8.800 | 0.090 | 0.0036 |
| Ex. 1 | | | | | | | | |
| Comp. | 2.886 | 2.572 | 4.500 | Tinuvin | 0.100 | 8.800 | 0.090 | 0.0036 |
| Ex. 2 | | | | 326 | | | | |
| Comp. | 2.886 | 2.572 | 4.500 | Tinuvin | 0.180 | 8.800 | 0.090 | 0.0036 |
| Ex. 3 | | | | 234 | | | | |
| Comp. | 0.000 | 0.000 | 0.000 | Uvinul | 0.250 | 25.000 | 0.000 | 0.0000 |
| Ex. 4 | | | | 3049 | | | | |
| Comp. | 0.000 | 0.000 | 0.000 | Uvinul | 0.250 | 25.000 | 0.000 | 0.0000 |
| Ex. 5 | | | | 3050 | | | | |

TABLE 2

| | | | | | | | Amount-of- | | |
|---|---|---|---|---|---|---|---|---|---|
| | | | | | | Mass ratio | substance | | |
| | | Mass ratio | Mass ratio | | Mass ratio | of | ratio of | Amount-of- | Mass ratio |
| | Mass ratio | of ultraviolet | of copper | Mass ratio | of | phosphonic | phosphonic | substance | of |
| | of ultraviolet | absorbent | component | of copper | phosphorus | acid to | acid to | ratio of | phosphonic |
| | absorbent | to | to | component | component | phosphoric | phosphoric | phosphonic | acid to |
| | to copper | phosphorus | phosphorus | to aluminum | to aluminum | acid ester | acid ester | acid to | ultraviolet |
| | component | component | component | component | component | compound | compound | copper ion | absorbent |
| Ex. 1 | 2.148 × 10⁻² | 7.760 × 10⁻² | 1.852 | 3.979 × 10² | 2.148 × 10² | 1.122 | 5.135 | 0.927 | 4.810 × 10¹ |
| Ex. 2 | 8.378 × 10⁻² | 1.549 × 10⁻¹ | 1.849 | 3.979 × 10² | 2.152 × 10² | 0.957 | 4.379 | 0.903 | 2.343 × 10¹ |
| Ex. 3 | 3.142 × 10⁻² | 5.804 × 10⁻² | 1.847 | 3.979 × 10² | 2.154 × 10² | 0.860 | 3.935 | 0.886 | 6.127 × 10¹ |
| Ex. 4 | 6.284 × 10⁻² | 1.163 × 10⁻¹ | 1.852 | 3.979 × 10² | 2.149 × 10² | 1.216 | 5.564 | 0.939 | 3.249 × 10¹ |
| Comp. | 0 | 0 | 1.852 | 3.979 × 10² | 2.148 × 10² | 1.122 | 5.135 | 0.927 | — |
| Ex. 1 | | | | | | | | | |
| Comp. | 6.982 × 10⁻² | 1.293 × 10⁻¹ | 1.852 | 3.979 × 10² | 2.148 × 10² | 1.122 | 5.135 | 0.927 | 2.886 × 10¹ |
| Ex. 2 | | | | | | | | | |
| Comp. | 1.257 × 10⁻¹ | 2.328 × 10⁻¹ | 1.852 | 3.979 × 10² | 2.148 × 10² | 1.122 | 5.135 | 0.927 | 1.603 × 10¹ |
| Ex. 3 | | | | | | | | | |
| Comp. | — | — | — | — | — | — | — | — | 0 |
| Ex. 4 | | | | | | | | | |
| Comp. | — | — | — | — | — | — | — | — | 0 |
| Ex. 5 | | | | | | | | | |

TABLE 3

| | | | | | | | T^{M}ᵢ₍₈₀₀₋ | T^{M}ᵢ₍₈₀₀₋ | T^{M}ᵢ₍₈₀₀₋ | | | Thick- |
|---|---|---|---|---|---|---|---|---|---|---|---|---|
| | | T^{M}ᵢ₍₃₅₀₋₃₈₀₎ | T^{M}ᵢ₍₃₅₀₋₃₈₅₎ | T^{M}ᵢ₍₃₅₀₋₃₉₀₎ | T^{M}ᵢ₍₄₀₀₎ | T^{A}ᵢ₍₄₈₀₋₅₈₀₎ | ₉₅₀₎ | ₁₁₀₀₎ | ₁₂₀₀₎ | λ⁵⁰_{i(UV)} | λ⁵⁰_{i(IR)} | ness |
| | | [%] | [%] | [%] | [%] | [%] | [%] | [%] | [%] | [nm] | [nm] | [μm] |
| Ex. | Incident | 0.06 | 0.08 | 0.11 | 0.34 | 88.09 | 1.73 | 1.73 | 1.90 | 445 | 707 | 79 |
| 1 | angle = | | | | | | | | | | | |
| | 0° | | | | | | | | | | | |
| | Incident | 0.03 | 0.04 | 0.06 | 0.20 | 87.57 | 1.16 | 1.16 | 1.29 | 447 | 704 | |
| | angle = | | | | | | | | | | | |
| | 35° | | | | | | | | | | | |
| | Incident | 0.01 | 0.02 | 0.03 | 0.11 | 87.00 | 0.75 | 0.75 | 0.84 | 448 | 700 | |
| | angle = | | | | | | | | | | | |
| | 45° | | | | | | | | | | | |
| | Incident | 0.01 | 0.01 | 0.01 | 0.06 | 83.98 | 0.51 | 0.51 | 0.57 | 449 | 696 | |
| | angle = | | | | | | | | | | | |
| | 55° | | | | | | | | | | | |
| Ex. | Incident | 0.00 | 0.00 | 0.00 | 0.00 | 86.88 | 0.97 | 0.97 | 1.08 | 453 | 702 | 90 |
| 2 | angle = | | | | | | | | | | | |
| | 0° | | | | | | | | | | | |
| | Incident | 0.00 | 0.00 | 0.00 | 0.00 | 86.25 | 0.61 | 0.61 | 0.69 | 454 | 698 | |
| | angle = | | | | | | | | | | | |
| | 35° | | | | | | | | | | | |
| | Incident | 0.00 | 0.00 | 0.00 | 0.00 | 85.56 | 0.37 | 0.37 | 0.42 | 455 | 695 | |
| | angle = | | | | | | | | | | | |
| | 45° | | | | | | | | | | | |
| | Incident | 0.00 | 0.00 | 0.00 | 0.00 | 82.48 | 0.24 | 0.24 | 0.27 | 457 | 691 | |
| | angle = | | | | | | | | | | | |
| | 55° | | | | | | | | | | | |
| Ex. | Incident | 0.36 | 0.43 | 0.57 | 1.35 | 88.31 | 1.78 | 1.78 | 1.96 | 442 | 708 | 78 |
| 3 | angle = | | | | | | | | | | | |
| | 0° | | | | | | | | | | | |
| | Incident | 0.21 | 0.25 | 0.35 | 0.88 | 87.81 | 1.20 | 1.20 | 1.33 | 443 | 704 | |
| | angle = | | | | | | | | | | | |
| | 35° | | | | | | | | | | | |
| | Incident | 0.11 | 0.14 | 0.20 | 0.55 | 87.26 | 0.78 | 0.78 | 0.87 | 445 | 700 | |
| | angle = | | | | | | | | | | | |
| | 45° | | | | | | | | | | | |
| | Incident | 0.07 | 0.08 | 0.12 | 0.37 | 84.25 | 0.53 | 0.53 | 0.60 | 446 | 696 | |
| | angle = | | | | | | | | | | | |
| | 55° | | | | | | | | | | | |
| Ex. | Incident | 0.00 | 0.00 | 0.00 | 0.02 | 87.45 | 1.24 | 1.24 | 1.37 | 450 | 704 | 85 |
| 4 | angle = | | | | | | | | | | | |
| | 0° | | | | | | | | | | | |
| | Incident | 0.00 | 0.00 | 0.00 | 0.01 | 86.87 | 0.80 | 0.80 | 0.90 | 451 | 700 | |
| | angle = | | | | | | | | | | | |
| | 35° | | | | | | | | | | | |
| | Incident | 0.00 | 0.00 | 0.00 | 0.00 | 86.23 | 0.50 | 0.50 | 0.56 | 452 | 697 | |
| | angle = | | | | | | | | | | | |
| | 45° | | | | | | | | | | | |
| | Incident | 0.00 | 0.00 | 0.00 | 0.00 | 83.18 | 0.33 | 0.33 | 0.37 | 454 | 693 | |
| | angle = | | | | | | | | | | | |
| | 55° | | | | | | | | | | | |

TABLE 4

| | | | | | | | T^{M}ᵢ₍₈₀₀₋ | T^{M}ᵢ₍₈₀₀₋ | T^{M}ᵢ₍₈₀₀₋ | | | Thick- |
|---|---|---|---|---|---|---|---|---|---|---|---|---|
| | | T^{M}ᵢ₍₃₅₀₋₃₈₀₎ | T^{M}ᵢ₍₃₅₀₋₃₈₅₎ | T^{M}ᵢ₍₃₅₀₋₃₉₀₎ | T^{M}ᵢ₍₄₀₀₎ | T^{A}ᵢ₍₄₈₀₋₅₈₀₎ | ₉₅₀₎ | ₁₁₀₀₎ | ₁₂₀₀₎ | λ⁵⁰_{i(UV)} | λ⁵⁰_{i(IR)} | ness |
| | | [%] | [%] | [%] | [%] | [%] | [%] | [%] | [%] | [nm] | [nm] | [μm] |
| Comp. | Incident | 77.69 | 9.38 | 80.41 | 81.94 | 89.01 | 2.08 | 2.08 | 2.28 | 354 | 709 | 74 |
| Ex. 1 | angle = | | | | | | | | | | | |
| | 0° | | | | | | | | | | | |
| Comp. | Incident | 2.29 | 5.78 | 13.74 | 44.45 | 87.81 | 2.41 | 2.41 | 2.64 | 354 | 709 | 72 |
| Ex. 2 | angle = | | | | | | | | | | | |
| | 0° | | | | | | | | | | | |
| | Incident | 1.01 | 3.14 | 9.03 | 37.86 | 86.91 | 1.08 | 1.08 | 1.20 | 354 | 709 | |
| | angle = | | | | | | | | | | | |
| | 35° | | | | | | | | | | | |
| | Incident | 0.50 | 1.84 | 6.25 | 32.89 | 86.13 | 0.53 | 0.53 | 0.61 | 354 | 709 | |
| | angle = | | | | | | | | | | | |
| | 45° | | | | | | | | | | | |
| | Incident | 0.73 | 2.43 | 7.50 | 34.51 | 83.62 | 0.78 | 0.78 | 0.88 | 354 | 709 | |
| | angle = | | | | | | | | | | | |
| | 55° | | | | | | | | | | | |
| Comp. | Incident | 5.25 | 15.06 | 30.14 | 57.34 | 86.85 | 2.78 | 2.78 | 3.03 | 354 | 709 | 69 |
| Ex. 3 | angle = | | | | | | | | | | | |
| | 0° | | | | | | | | | | | |
| | Incident | 2.79 | 10.10 | 23.56 | 51.65 | 85.76 | 1.29 | 1.29 | 1.43 | 354 | 709 | |
| | angle = | | | | | | | | | | | |
| | 35° | | | | | | | | | | | |
| | Incident | 1.60 | 7.12 | 18.98 | 47.13 | 84.81 | 0.65 | 0.65 | 0.74 | 354 | 709 | |
| | angle = | | | | | | | | | | | |
| | 45° | | | | | | | | | | | |
| | Incident | 2.14 | 8.45 | 20.83 | 48.05 | 82.45 | 0.94 | 0.94 | 1.05 | 354 | 709 | |
| | angle = | | | | | | | | | | | |
| | 55° | | | | | | | | | | | |
| Comp. | Incident | 1.18 | 3.50 | 9.63 | 40.78 | 91.03 | 92.04 | 92.05 | 92.06 | 402 | — | 28 |
| Ex. 4 | angle = | | | | | | | | | | | |
| | 0° | | | | | | | | | | | |
| Comp. | Incident | 1.55 | 6.43 | 18.50 | 57.15 | 90.93 | 92.50 | 92.50 | 92.50 | 398 | — | 28 |
| Ex. 5 | angle = | | | | | | | | | | | |
| | 0° | | | | | | | | | | | |

TABLE 5

| | | Tᵢ₍₅₅₀₎/ | Tᵢ₍₅₅₀₎/ | Tᵢ₍₅₅₀₎/ | Tᵢ₍₅₅₀₎/ | Tᵢ₍₅₅₀₎/ | Tᵢ₍₆₈₀₎/ |
|---|---|---|---|---|---|---|---|
| | | Tᵢ₍₄₀₀₎ | Tᵢ₍₈₀₀₎ | Tᵢ₍₉₀₀₎ | Tᵢ₍₁₀₀₀₎ | Tᵢ₍₁₂₀₀₎ | Tᵢ₍₈₀₀₎ |
| Example 1 | Incident angle = 0° | 2.60 × 10² | 5.15 × 10¹ | 3.71 × 10² | 2.82 × 10² | 4.68 × 10¹ | 4.01 × 10¹ |
| | Incident angle = 35° | 4.53 × 10² | 7.63 × 10¹ | 6.69 × 10² | 4.96 × 10² | 6.88 × 10¹ | 5.80 × 10¹ |
| | Incident angle = 45° | 8.35 × 10² | 1.18 × 10² | 1.28 × 10³ | 9.23 × 10² | 1.05 × 10² | 8.71 × 10¹ |
| | Incident angle = 55° | 1.38 × 10³ | 1.68 × 10² | 2.19 × 10³ | 1.53 × 10³ | 1.49 × 10² | 1.21 × 10² |
| Example 2 | Incident angle = 0° | 6.22 × 10⁴ | 9.09 × 10¹ | 8.71 × 10² | 6.38 × 10² | 8.15 × 10¹ | 6.85 × 10¹ |
| | Incident angle = 35° | 1.88 × 10⁵ | 1.43 × 10² | 1.71 × 10³ | 1.22 × 10³ | 1.27 × 10² | 1.05 × 10² |
| | Incident angle = 45° | 6.32 × 10⁵ | 2.34 × 10² | 3.61 × 10³ | 2.47 × 10³ | 2.06 × 10² | 1.66 × 10² |
| | Incident angle = 55° | 1.71 × 10⁶ | 3.52 × 10² | 6.64 × 10³ | 4.42 × 10³ | 3.05 × 10² | 2.43 × 10² |
| Example 3 | Incident angle = 0° | 6.62 × 10¹ | 5.00 × 10¹ | 3.54 × 10² | 2.71 × 10² | 4.55 × 10¹ | 3.90 × 10¹ |
| | Incident angle = 35° | 1.01 × 10² | 7.39 × 10¹ | 6.38 × 10² | 4.74 × 10² | 6.67 × 10¹ | 5.63 × 10¹ |
| | Incident angle = 45° | 1.60 × 10² | 1.14 × 10² | 1.22 × 10³ | 8.77 × 10² | 1.02 × 10² | 8.42 × 10¹ |
| | Incident angle = 55° | 2.33 × 10² | 1.62 × 10² | 2.06 × 10³ | 1.45 × 10³ | 1.43 × 10² | 1.17 × 10² |
| Example 4 | Incident angle = 0° | 4.03 × 10³ | 7.16 × 10¹ | 6.08 × 10² | 4.53 × 10² | 6.46 × 10¹ | 5.47 × 10¹ |
| | Incident angle = 35° | 9.23 × 10³ | 1.10 × 10² | 1.15 × 10³ | 8.34 × 10² | 9.80 × 10¹ | 8.16 × 10¹ |
| | Incident angle = 45° | 2.30 × 10⁴ | 1.76 × 10² | 2.34 × 10³ | 1.63 × 10³ | 1.55 × 10² | 1.27 × 10² |
| | Incident angle = 55° | 4.86 × 10⁴ | 2.58 × 10² | 4.16 × 10³ | 2.83 × 10³ | 2.26 × 10² | 1.82 × 10² |

TABLE 6

| | | Tᵢ₍₅₅₀₎/ | Tᵢ₍₅₅₀₎/ | Tᵢ₍₅₅₀₎/ | Tᵢ₍₅₅₀₎/ | Tᵢ₍₅₅₀₎/ | Tᵢ₍₆₈₀₎/ |
|---|---|---|---|---|---|---|---|
| | | Tᵢ₍₄₀₀₎ | Tᵢ₍₈₀₀₎ | Tᵢ₍₉₀₀₎ | Tᵢ₍₁₀₀₀₎ | Tᵢ₍₁₂₀₀₎ | Tᵢ₍₈₀₀₎ |
| Comparative | Incident | 1.10 | 4.31 × 10¹ | 2.84 × 10² | 2.19 × 10² | 3.94 × 10¹ | 3.39 × 10¹ |
| Example1 | angle = 0° | | | | | | |
| Comparative | Incident | 2.00 | 3.69 × 10¹ | 2.25 × 10² | 1.75 × 10² | 3.37 × 10¹ | 2.94 × 10¹ |
| Example 2 | angle = 0° | | | | | | |
| | Incident | 2.33 | 8.17 × 10¹ | 7.42 × 10² | 5.48 × 10² | 7.32 × 10¹ | 6.20 × 10¹ |
| | angle = 35° | | | | | | |
| | Incident | 2.66 | 1.64 × 10² | 2.12 × 10³ | 1.49 × 10³ | 1.45 × 10² | 1.19 × 10² |
| | angle = 45° | | | | | | |
| | Incident | 2.46 | 1.09 × 10² | 1.14 × 10³ | 8.25 × 10² | 9.67 × 10¹ | 8.10 × 10¹ |
| | angle = 55° | | | | | | |
| Comparative | Incident | 1.53 | 3.16 × 10¹ | 1.78 × 10² | 1.41 × 10² | 2.90 × 10¹ | 2.55 × 10¹ |
| Example 3 | angle = 0° | | | | | | |
| | Incident | 1.69 | 6.77 × 10¹ | 5.56 × 10² | 4.19 × 10² | 6.10 × 10¹ | 5.22 × 10¹ |
| | angle = 35° | | | | | | |
| | Incident | 1.83 | 1.32 × 10² | 1.53 × 10³ | 1.09 × 10³ | 1.17 × 10² | 9.77 × 10¹ |
| | angle = 45° | | | | | | |
| | Incident | 1.74 | 8.90 × 10¹ | 8.44 × 10² | 6.20 × 10² | 7.96 × 10¹ | 6.75 × 10¹ |
| | angle = 55° | | | | | | |
| Comparative | Incident | 2.24 | 9.95 × 10⁻¹ | 9.93 × 10-1 | 9.92 × 10⁻¹ | 9.91 × 10⁻¹ | 9.99 × 10⁻¹ |
| Example 4 | angle = 0° | | | | | | |
| Comparative | Incident | 1.59 | 9.91 × 10⁻¹ | 9.89 × 10-1 | 9.89 × 10⁻¹ | 9.88 × 10⁻¹ | 9.98 × 10⁻¹ |
| Example 5 | angle = 0° | | | | | | |

1-20. (canceled)

21. A light absorber comprising a light absorbent,
wherein a first transmitted light incident on the light absorber at an incident angle of 0 degree has a first transmission spectrum, and
the first transmission spectrum has the following (I), (II), (III), and (IV):
(I) an average transmittance of 78% or more in a wavelength range of 480 nm to 580 nm;
(II) a maximum transmittance of 1% or less in a wavelength range of 350 nm to 380 nm;
(III) a maximum transmittance of 7% or less in a wavelength range of 800 nm to 950 nm; and
(IV) a transmittance of 10% or less at a wavelength of 400 nm.

22. The light absorber according to claim 21, wherein the transmission spectrum further has a first wavelength at which a transmittance is 50% in a wavelength range of 405 nm to 480 nm.

23. The light absorber according to claim 21, wherein the transmission spectrum further has a second wavelength at which a transmittance is 50% in a wavelength range of 680 nm to 760 nm.

24. The light absorber according to claim 21, wherein the transmission spectrum further has a maximum transmittance of 15% or less in a wavelength range of 800 nm to 1200 nm.
